(19) United States
(12) Patent Application Publication
(10) Pub. No.: US 2015/0353871 A1
(43) Pub. Date: Dec. 10, 2015

(54) Polypeptides for Cleaning or Detergent Compositions

(71) Applicant: NOVOZYMES A/S, Bagsvaerd (DK)

(72) Inventors: Jens Oebro, Humelbaek (DK); Maria Norman Hockauf, Stenloese (DK)

(73) Assignee: NOVOZYMES A/S, Bagsvaerd (DK)

(21) Appl. No.: 14/437,122

(22) PCT Filed: Nov. 28, 2013
(86) PCT No.: PCT/EP2013/074947

§ 371 Date: Apr. 20, 2015

Related U.S. Application Data
(60) Provisional application No. 61/733,101, filed on Dec. 4, 2012.

(30) Foreign Application Priority Data
Nov. 30, 2012 (EP) 12195057.0

(51) Int. Cl. C11D 3/386

(52) U.S. Cl. CPC C11D 3/38636; C11D 3/386; C11D 3/38645; C11D 3/38627

(57) ABSTRACT

The present invention relates to cleaning or detergent compositions comprising polypeptides exhibiting beta-glucanase activity and one or more amylases and their use thereof in cleaning or detergent applications and processes such as cleaning hard-surfaces, dish wash and laundering. The invention also relates to polynucleotides encoding the polypeptides as well as methods of producing the polypeptides.

### REFERENCE TO A SEQUENCE LISTING

This application contains a Sequence Listing in computer readable form, which is incorporated herein by reference.

### BACKGROUND OF THE INVENTION

1. Field of the Invention

The present invention relates to cleaning or detergent compositions comprising polypeptides exhibiting beta-glucanase activity and one or more amylases and their use thereof in cleaning or detergent applications and processes such as cleaning hard-surfaces, dish wash and laundering. The invention also relates to polynucleotides encoding the polypeptides as well as methods of producing the polypeptides.

2. Background of the Invention

Beta-glucans are polysaccharides that only contain glucose as structural components, and in which the glucose units are linked by beta-glycosidic bonds. Cellulose is one type of beta-glucan in which all of the glucose units are linked by beta-1,4-glucosidic bonds. This feature results in the formation of insoluble cellulose micro-fibrils meaning that microbial hydrolysis of cellulose to glucose requires the use of endo-glucanases (EC 3.2.1.4), cellobiohydrolases (EC 3.2.1.91) and beta-glucosidases (EC 3.2.1.21).

Beta-glucans can also be linked by beta-1,3-glucosidic bonds (which can be found in the cell walls of baker's yeast, e.g. Saccharomyces cerevisiae), beta-1,6-glucosidic bonds as well as combinations of beta-1,3-, beta-1,4- and beta-1,6-glucosidic bonds. The combination of beta-1,3- and beta-1,4-glucosidic bonds can be found in the soluble fibre from oats and barley and beta-glucanases (E.C. 3.2.1.73), also known as a licheninases, can be used to catalyse the hydrolysis of the beta-1,4-glucosidic bonds to give beta-glucans.

The removal of oat and barley containing stains in dish wash and laundry is a recognised problem, and there is considerable interest in finding enzymes that help break down the beta-glucans from e.g. oats and barley.

### DESCRIPTION OF THE RELATED ART

Beta-glucanases from Bacillus amyloliquefaciens are known in the art. There are a number of publications on the same beta-glucanase from Bacillus amyloliquefaciens (SEQ ID NO: 2). Yang et al published the complete genome sequence of Bacillus amyloliquefaciens XH7 in 2011, J Bacteriol. 193:5593-5594 (Uniprot G0IID4). Li et al describe the thermally stable mutant beta-1,3-1,4-glucanase in CN101899458 (Geneseqp: AZI25249). Zhang et al, published the complete genome sequence of Bacillus amyloliquefaciens TA208 in 2011, J Bacteriol. 193:3142-3143 (Uniprot F4EB62). Ruckert et al, published the complete genome sequence of Bacillus amyloliquefaciens DSM7(T) in 2011, J Biotechnol. 155:78-85 (Uniprot E1UTP1) and Geng et al, published the complete genome sequence of Bacillus amyloliquefaciens LL3 in 2011, J Bacteriol. 193:3393-3394 (Uniprot B2MVK2).

Other closely related beta-glucanases to SEQ ID NO: 2 include a beta-glucanase from Bacillus amyloliquefaciens (Uniprot 13QQ20, having 98.3% homology to SEQ ID NO: 2), a beta-glucanase from Bacillus amyloliquefaciens (Uniprot P07980, having 97.9% homology to SEQ ID NO: 2) in Hofemeister, 1986, Gene 49:177-187, and a beta-glucanase from Bacillus subtilis as described by van Rensburg, 1997, J Biotechnol. 55:43-53 (Uniprot Q45691, having 97.5% homology to SEQ ID NO: 2). However, none of these publications relate to the use of a beta-glucanase in cleaning or detergent compositions.

There are also references to beta-glucanases in the patent literature. CN1834249, CN1834250 and CN1834251 describe beta-glucanases from Bacillus species (Geneseqp AQZ99132, APQ75821 and AQE66605) having 100% homology to SEQ ID NO: 2 which are then fused with a xylanase. CN102021191 describes 4 very closely related beta-glucanases for liquefying starch from Bacillus species (Geneseqp AZI42344 to AZI42347) having 97.4 to 100% homology to SEQ ID NO. 2. US2008148432 describes three Bacillus amyloliquefaciens proteins (Geneseqp ATZ25520, ATZ33161 and ATZ59161) for use in transgenic plants having 97.1 to 99.6% homology to SEQ ID NO. 2. EP2295582 describes three proteins from Bacillus amyloliquefaciens (Geneseqp AZR70078, AZR73562 and AZR82315) for use in transgenic plants having 97.5 to 99.6% homology to SEQ ID NO. 2. However, none of these applications relate to the use of a beta-glucanase in cleaning or detergent compositions.

WO 2005056744 describes the use of hybrid/fused enzymes (Geneseqp AEA48942, AEA48952 and AEA48947 having 91.2% sequence identity to SEQ ID NO: 2) comprising a hydrolytically active unit and a cationic binding unit whereby the cationic binding unit improves and prolongs the adhesion of the enzyme to biofilms in order to remove biofilms on surfaces e.g. in WC's, for sterilizing or disinfecting, for detergent or cleansing preparations, and for cosmetic and/or pharmaceutical preparations.

WO 05/003319 describes the use of a polypeptide (Geneseqp AZS42633, SEQ ID NO: 494, having 91.2% sequence identity to SEQ ID NO: 2) for a large number of uses, including detergents. However, there is no experimental data on this polypeptide within the application.

EP 1000136 discloses using the combination of an amylase and a beta-glucanase for hard surface cleaning.

### SUMMARY OF THE INVENTION

In one aspect, the invention relates to a cleaning or detergent composition comprising a beta-glucanase selected from the group consisting of:
(a) a polypeptide having at least 80% sequence identity to the mature polypeptide of SEQ ID NO: 2;
(b) a polypeptide encoded by a polynucleotide that hybridizes under medium stringency conditions, medium-high stringency conditions, high stringency conditions, or very high stringency conditions with the mature polypeptide coding sequence of SEQ ID NO: 1 or the full-length complement thereof;
(c) a polypeptide encoded by a polynucleotide having at least 80% sequence identity to the mature polypeptide coding sequence of SEQ ID NO: 1;
(d) a variant of the mature polypeptide of SEQ ID NO: 2 comprising a substitution, deletion, and/or insertion at one or more (e.g. several) positions; and
(e) a fragment of the polypeptide of (a), (b), (c), or (d) that has beta-glucanase activity; and one or more amylases.

An embodiment of the invention is a cleaning or detergent composition comprising a beta-glucanase of the invention together with one or more alpha-amylases. A further embodiment of the invention is a cleaning or detergent composition comprising a beta-glucanase together with one or more amylases and one or more further enzymes selected from the group comprising of proteases, lipases, cutinases, cellulases, endoglucanases, xyloglucanases, pectinases, pectin lyases, xanthanases, peroxidaes, haloperoxygenases, catalases, mannanases, or any mixture thereof. Another embodiment is cleaning or detergent composition of the invention having an enzyme detergency benefit or improved wash performance in cleaning or detergent applications.

In another aspect, the invention relates to the use of a beta-glucanase selected from the group consisting of:
(a) a polypeptide having at least 80% sequence identity to the mature polypeptide of SEQ ID NO: 2;
(b) a polypeptide encoded by a polynucleotide that hybridizes under medium stringency conditions, medium-high stringency conditions, high stringency conditions, or very high stringency conditions with the mature polypeptide coding sequence of SEQ ID NO: 1 or the full-length complement thereof;
(c) a polypeptide encoded by a polynucleotide having at least 80% sequence identity to the mature polypeptide coding sequence of SEQ ID NO: 1;
(d) a variant of the mature polypeptide of SEQ ID NO: 2 comprising a substitution, deletion, and/or insertion at one or more (e.g. several) positions; and
(e) a fragment of the polypeptide of (a), (b), (c), or (d) that has beta-glucanase activity; and one or more amylases for dish wash or laundering.

An embodiment of the invention is the use of a beta-glucanase together with one or more proteases, and optionally one or more further enzymes such as proteases, lipases, cutinases, cellulases, endoglucanases, xyloglucanases, pectinases, pectin lyases, xanthanases, peroxidaes, haloperoxygenases, catalases, mannanases, or any mixture thereof, for dish wash or laundering.

### OVERVIEW OF SEQUENCE LISTING

SEQ ID NO: 1 is the cDNA sequence of the beta-glucanase from Bacillus amyloliquefacience.

SEQ ID NO: 2 is the amino acid sequence as deduced from SEQ ID NO: 1.

SEQ ID NO: 3 is derived from B. licheniformis.

SEQ ID NO: 4 is derived from Bacillus stearothermophilus

SEQ ID NO: 5 is a hybrid peptide comprising amino acid residues 1-33 of SEQ ID NO: 6 of WO 2006/066594 and amino acid residues 36-483 of SEQ ID NO: 4 of WO 2006/066594

SEQ ID NO: 6 is derived from Bacillus sp.

SEQ ID NO: 7 is derived from Bacillus sp. NCIB 12512

SEQ ID NO: 8 is derived from Bacillus sp. NCIB 12513

SEQ ID NO: 9 is derived from Bacillus sp. #707

SEQ ID NO: 10 is derived from Bacillus sp. A 7-7 (DSM 12368)

SEQ ID NO: 11 is derived from Bacillus amyloliquefaciens

SEQ ID NO: 12 is derived from Bacillus sp. TS-23

SEQ ID NO: 13 is Substilisin 309 derived from Bacillus lentus

SEQ ID NO: 14 is derived from Bacillus Lentus

### DEFINITIONS

Allelic variant: The term “allelic variant” means any of two or more alternative forms of a gene occupying the same chromosomal locus. Allelic variation arises naturally through mutation, and may result in polymorphism within populations. Gene mutations can be silent (no change in the encoded polypeptide) or may encode polypeptides having altered amino acid sequences. An allelic variant of a polypeptide is a polypeptide encoded by an allelic variant of a gene.

Beta-glucanase: The term “beta-glucanase” means a (1,3)-(1,4)-β-D-glucan 4-glucanohydrolase (E.C. 3.2.1.73) that catalyzes the hydrolysis of (1,4)-β-D-glucosidic linkages in β-D-glucans containing (1,3)- and (1,4)-bonds. Thus the beta-glucanase acts on lichenin and cereal β-D-glucans, but not on β-D-glucans containing only 1,3- or 1,4-bonds. Beta-glucanase activity can be determined using the beta-glucanase activity (AZCL-beta-glucan assay) as defined in the Enzyme Assay section.

cDNA: The term “cDNA” means a DNA molecule that can be prepared by reverse transcription from a mature, spliced, mRNA molecule obtained from a eukaryotic or prokaryotic cell. cDNA lacks intron sequences that may be present in the corresponding genomic DNA. The initial, primary RNA transcript is a precursor to mRNA that is processed through a series of steps, including splicing, before appearing as mature spliced mRNA.

Cleaning or Detergent Application: the term “cleaning or detergent application” means applying the beta-glucanase of the invention, optionally with one or more amylases, in any composition for the purpose of cleaning or washing, by hand, machine or automated, a hard surface or a textile.

Cleaning or Detergent Composition: the term “cleaning or detergent composition” refers to compositions that find use in the removal of undesired compounds from items to be cleaned, such as textiles, dishes, and hard surfaces. The terms encompass any materials/compounds selected for the particular type of cleaning composition desired and the form of the product (e.g., liquid, gel, powder, granulate, paste, or spray compositions) and includes, but is not limited to, detergent compositions (e.g., liquid and/or solid laundry detergents and fine fabric detergents; hard surface cleaning formulations, such as for glass, wood, ceramic and metal counter tops and windows; carpet cleaners; oven cleaners; fabric fresheners; fabric softeners; and textile and laundry pre-spotters, as well as dish wash detergents). In addition to the beta-glucanase of the invention, the detergent formulation contains one or more amylases, optionally one or more additional enzymes, and/or components such as surfactants, builders, chelators or chelating agents, bleach system or bleach components, polymers, fabric conditioners, foam boosters, suds suppressors, dyes, perfume, tarnish inhibitors, optical brighteners, bactericides, fungicides, soil suspending agents, anti-corrosion agents, enzyme inhibitors or stabilizers, enzyme activators, bluing agents, fluorescent dyes, antioxidants, and solubilizers.

Coding sequence: The term “coding sequence” means a polynucleotide, which directly specifies the amino acid sequence of a polypeptide. The boundaries of the coding sequence are generally determined by an open reading frame, which begins with a start codon such as ATG, GTG, or TTG and ends with a stop codon such as TAA, TAG, or TGA. The coding sequence may be a genomic DNA, cDNA, synthetic DNA, or a combination thereof.

Colour clarification: During washing and wearing loose or broken fibers can accumulate on the surface of the fabrics. One consequence can be that the colours of the fabric appear less bright or less intense because of the surface contaminations. Removal of the loose or broken fibers from the textile will partly restore the original colours and looks of the textile. By the term “colour clarification”, as used herein, is meant the partial restoration of the initial colours of textile.

Control sequences: The term “control sequences” means nucleic acid sequences necessary for expression of a polynucleotide encoding a mature polypeptide of the present invention. Each control sequence may be native (i.e., from the same gene) or foreign (i.e., from a different gene) to the polynucleotide encoding the polypeptide or native or foreign to each other. Such control sequences include, but are not limited to, a leader, polyadenylation sequence, propeptide sequence, promoter, signal peptide sequence, and transcription terminator. At a minimum, the control sequences include a promoter, and transcriptional and translational stop signals. The control sequences may be provided with linkers for the purpose of introducing specific restriction sites facilitating ligation of the control sequences with the coding region of the polynucleotide encoding a polypeptide.

Delta remission value (ΔRem): The terms “Delta remission” or “Delta remission value” are defined herein as the result of a reflectance or remission measurement at 460 nm. The swatch is measured with one swatch of similar colour as background, preferably a swatch from a repetition wash. A swatch representing each swatch type is measured before wash. The Delta remission is the remission value of the washed swatch minus the remission value of the unwashed swatch.

Delta enzyme remission value (ΔRem enzyme value): The term “Delta enzyme remission value” is defined herein as the result of a reflectance or remission measurement at 460 nm. The swatch is measured with one swatch of similar colour as background, preferably a swatch from a repetition wash. A swatch representing each swatch type is measured before wash. The Delta remission is the remission value of the swatch washed in detergent with one or more enzymes present minus the remission value of a similar swatch washed in a detergent without enzyme present.

Dish wash: The term “dish wash” refers to all forms of washing dishes, e.g. by hand or automatic dish wash. Washing dishes includes, but is not limited to, the cleaning of all forms of crockery such as plates, cups, glasses, bowls, all forms of cutlery such as spoons, knives, forks and serving utensils as well as ceramics, plastics, metals, china, glass and acrylics.

Dish washing composition: The term “dish washing composition” refers to all forms of compositions for cleaning hard surfaces. The present invention is not restricted to any particular type of dish wash composition or any particular detergent.

Enzyme Detergency benefit: The term “enzyme detergency benefit” is defined herein as the advantageous effect an enzyme may add to a detergent compared to the same detergent without the enzyme. Important detergency benefits which can be provided by enzymes are stain removal with no or very little visible soils after washing and or cleaning, prevention or reduction of redeposition of soils released in the washing process an effect that also is termed anti-redeposition, restoring fully or partly the whiteness of textiles, which originally were white but after repeated use and wash have obtained a greyish or yellowish appearance an effect that also is termed whitening. Textile care benefits, which are not directly related to catalytic stain removal or prevention of redeposition of soils are also important for enzyme detergency benefits. Examples of such textile care benefits are prevention or reduction of dye transfer from one fabric to another fabric or another part of the same fabric an effect that is also termed dye transfer inhibition or anti-backstaining, removal of protruding or broken fibers from a fabric surface to decrease pilling tendencies or remove already existing pills or fuzz an effect that also is termed anti-pilling, improvement of the fabric-softness, colour clarification of the fabric and removal of particulate soils which are trapped in the fibers of the fabric or garment. Enzymatic bleaching is a further enzyme detergency benefit where the catalytic activity generally is used to catalyze the formation of bleaching component such as hydrogen peroxide or other peroxides.

Expression: The term “expression” includes any step involved in the production of a polypeptide including, but not limited to, transcription, post-transcriptional modification, translation, post-translational modification, and secretion.

Expression vector: The term “expression vector” means a linear or circular DNA molecule that comprises a polynucleotide encoding a polypeptide and is operably linked to control sequences that provide for its expression.

Fragment: The term “fragment” means a polypeptide or a catalytic domain having one or more (e.g., several) amino acids absent from the amino and/or carboxyl terminus of a mature polypeptide or domain; wherein the fragment has beta-glucanase activity. In one aspect, a fragment contains at least 202 amino acid residues (e.g., amino acids 7 to 208 of SEQ ID NO: 2); in another aspect a fragment contains at least 206 amino acid residues (e.g., amino acids 5 to 210 of SEQ ID NO: 2); in a further aspect a fragment contains at least 210 amino acid residues (e.g., amino acids 3 to 212 of SEQ ID NO: 2).

Host cell: The term “host cell” means any cell type that is susceptible to transformation, transfection, transduction, or the like with a nucleic acid construct or expression vector comprising a polynucleotide of the present invention. The term “host cell” encompasses any progeny of a parent cell that is not identical to the parent cell due to mutations that occur during replication.

Isolated: The term “isolated” means a substance in a form or environment that does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., multiple copies of a gene encoding the substance; use of a stronger promoter than the promoter naturally associated with the gene encoding the substance). An isolated substance may be present in a fermentation broth sample.

Laundering: The term “laundering” relates to both household laundering and industrial laundering and means the process of treating textiles with a solution containing a cleaning or detergent composition of the present invention. The laundering process can for example be carried out using e.g. a household or an industrial washing machine or can be carried out by hand.

Mature polypeptide: The term “mature polypeptide” means a polypeptide in its final form following translation and any post-translational modifications, such as N-terminal processing, C-terminal truncation, glycosylation, phosphorylation, etc. In one aspect, the mature polypeptide is amino acids 1 to 214 of SEQ ID NO: 2 based on the prediction program SignalP (Nielsen et al., 1997, Protein Engineering 10: 1-6), that also predicts amino acids −25 to −1 of SEQ ID NO: 2 are a signal peptide. It is known in the art that a host cell may produce a mixture of two of more different mature polypeptides (i.e., with a different C-terminal and/or N-terminal amino acid) expressed by the same polynucleotide.

Mature polypeptide coding sequence: The term “mature polypeptide coding sequence” means a polynucleotide that encodes a mature polypeptide having beta-glucanase activity. In one aspect, the mature polypeptide coding sequence is nucleotides 76 to 717 of SEQ ID NO: 1 based on the prediction program SignalP (Nielsen et al., 1997, supra)] that also predicts nucleotides 1 to 75 of SEQ ID NO: 1 encode a signal peptide.

Nucleic acid construct: The term “nucleic acid construct” means a nucleic acid molecule, either single- or double-stranded, which is isolated from a naturally occurring gene or is modified to contain segments of nucleic acids in a manner that would not otherwise exist in nature or which is synthetic, which comprises one or more control sequences.

Operably linked: The term “operably linked” means a configuration in which a control sequence is placed at an appropriate position relative to the coding sequence of a polynucleotide such that the control sequence directs expression of the coding sequence.

Sequence identity: The relatedness between two amino acid sequences or between two nucleotide sequences is described by the parameter “sequence identity”. For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the—nobrief option) is used as the percent identity and is calculated as follows:

(Identical Deoxyribonucleotides×100)/(Length of Alignment—Total Number of Gaps in Alignment)

Stringency conditions: The different strigency conditions are defined as follows.

The term “very low stringency conditions” means for probes of at least 100 nucleotides in length, prehybridization and hybridization at 42° C. in 5×SSPE, 0.3% SDS, 200 micrograms/ml sheared and denatured salmon sperm DNA, and 25% formamide, following standard Southern blotting procedures for 12 to 24 hours. The carrier material is finally washed three times each for 15 minutes using 2×SSC, 0.2% SDS at 45° C.

The term “low stringency conditions” means for probes of at least 100 nucleotides in length, prehybridization and hybridization at 42° C. in 5×SSPE, 0.3% SDS, 200 micrograms/ml sheared and denatured salmon sperm DNA, and 25% formamide, following standard Southern blotting procedures for 12 to 24 hours. The carrier material is finally washed three times each for 15 minutes using 2×SSC, 0.2% SDS at 50° C.

The term “medium stringency conditions” means for probes of at least 100 nucleotides in length, prehybridization and hybridization at 42° C. in 5×SSPE, 0.3% SDS, 200 micrograms/ml sheared and denatured salmon sperm DNA, and 35% formamide, following standard Southern blotting procedures for 12 to 24 hours. The carrier material is finally washed three times each for 15 minutes using 2×SSC, 0.2% SDS at 55° C.

The term “medium-high stringency conditions” means for probes of at least 100 nucleotides in length, prehybridization and hybridization at 42° C. in 5×SSPE, 0.3% SDS, 200 micrograms/ml sheared and denatured salmon sperm DNA, and 35% formamide, following standard Southern blotting procedures for 12 to 24 hours. The carrier material is finally washed three times each for 15 minutes using 2×SSC, 0.2% SDS at 60° C.

The term “high stringency conditions” means for probes of at least 100 nucleotides in length, prehybridization and hybridization at 42° C. in 5×SSPE, 0.3% SDS, 200 micrograms/ml sheared and denatured salmon sperm DNA, and 50% formamide, following standard Southern blotting procedures for 12 to 24 hours. The carrier material is finally washed three times each for 15 minutes using 2×SSC, 0.2% SDS at 65° C.

The term “very high stringency conditions” means for probes of at least 100 nucleotides in length, prehybridization and hybridization at 42° C. in 5×SSPE, 0.3% SDS, 200 micrograms/ml sheared and denatured salmon sperm DNA, and 50% formamide, following standard Southern blotting procedures for 12 to 24 hours. The carrier material is finally washed three times each for 15 minutes using 2×SSC, 0.2% SDS at 70° C.

Subsequence: The term “subsequence” means a polynucleotide having one or more (e.g., several) nucleotides absent from the 5′ and/or 3′ end of a mature polypeptide coding sequence; wherein the subsequence encodes a fragment having beta-glucanase activity. In one aspect, a subsequence contains at least 606 nucleotides (e.g., nucleotides 19 to 624 of SEQ ID NO: 1), e.g., and at least 618 nucleotides (e.g., nucleotides 13 to 630 of SEQ ID NO: 1); e.g., and at least 630 nucleotides (e.g., nucleotides 7 to 636 of SEQ ID NO: 1).

Textile: The term “textile” means any textile material including yarns, yarn intermediates, fibers, non-woven materials, natural materials, synthetic materials, and any other textile material, fabrics made of these materials and products made from fabrics (e.g., garments, cloths and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, ramie, cellulose acetate fibers (tricell), lyocell or blends thereof. The textile or fabric may also be non-cellulose based such as natural polyamides including wool, camel, cashmere, mohair, rabit and silk or synthetic polymer such as nylon, aramid, polyester, acrylic, polypropylen and spandex/elastane, or blends thereof as well as blend of cellulose based and non-cellulose based fibers. Examples of blends are blends of cotton and/or rayon/viscose with one or more companion material such as wool, synthetic fibers (e.g. polyamide fibers, acrylic fibers, polyester fibers, polyvinyl alcohol fibers, polyvinyl chloride fibers, polyurethane fibers, polyurea fibers, aramid fibers), and cellulose-containing fibers (e.g. rayon/viscose, ramie, flax/linen, jute, cellulose acetate fibers, lyocell). Fabric may be conventional washable laundry, for example stained household laundry. When the term fabric or garment is used it is intended to include the broader term textiles as well.

Textile care benefit: “Textile care benefits”, which are not directly related to catalytic stain removal or prevention of redeposition of soils, are also important for enzyme detergency benefits. Examples of such textile care benefits are prevention or reduction of dye transfer from one textile to another textile or another part of the same textile an effect that is also termed dye transfer inhibition or anti-backstaining, removal of protruding or broken fibers from a textile surface to decrease pilling tendencies or remove already existing pills or fuzz an effect that also is termed anti-pilling, improvement of the textile-softness, colour clarification of the textile and removal of particulate soils which are trapped in the fibers of the textile. Enzymatic bleaching is a further enzyme detergency benefit where the catalytic activity generally is used to catalyze the formation of bleaching component such as hydrogen peroxide or other peroxides or other bleaching species.

Variant: The term “variant” means a beta-glucanase having an enzyme detergency benefit comprising of a substitution, insertion, and/or deletion, at one or more (e.g. several) positions. A substitution means replacement of the amino acid occupying a position with a different amino acid; a deletion means removal of the amino acid occupying a position; and an insertion means adding one or more (e.g. several) amino acids adjacent to and immediately following the amino acid occupying a position.

In another embodiment, the term “variant” means a beta-glucanase having an enzyme detergency benefit comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding one or more (e.g. several) amino acids adjacent to and immediately following the amino acid occupying a position.

Wash performance: The term “wash performance” is defined herein as the ability of an enzyme or a blend of enzymes to remove stains present on an object to be cleaned during e.g. wash or hard surface cleaning relative to the wash performance without one or more on the enzymes present. The improvement in the wash performance may be quantified by calculating the so-called remission value (REM) as defined in the Terg-O-Meter (TOM) wash assay. See also the wash performance test in Example 2.

Whiteness: The term “Whiteness” is defined herein as a broad term with different meanings in different regions and for different customers. Loss of whiteness can e.g. be due to greying, yellowing, or removal of optical brighteners/hueing agents. Greying and yellowing can be due to soil redeposition, body soils, colouring from e.g. iron and copper ions or dye transfer. Whiteness might include one or several issues from the list below: colorant or dye effects; incomplete stain removal (e.g. body soils, sebum etc.); re-deposition (greying, yellowing or other discolouration's of the object) (removed soils re-associates with other part of textile, soiled or unsoiled); chemical changes in textile during application; and clarification or brightening of colours.

### Nomenclature of Variants

In describing variants, the nomenclature described below is adapted for ease of reference. The accepted IUPAC single letter or three letter amino acid abbreviation is employed.

Substitutions: For an amino acid substitution, the following nomenclature is used: Original amino acid, position, substituted amino acid. Accordingly, the substitution of threonine at position 226 with alanine is designated as “Thr226Ala” or “T226A”. Multiple mutations are separated by addition marks (“+”), e.g., “Gly205Arg+Ser411Phe” or “G205R+5411 F”, representing substitutions at positions 205 and 411 of glycine (G) with arginine (R) and serine (S) with phenylalanine (F), respectively.

Deletions: For an amino acid deletion, the following nomenclature is used: Original amino acid, position, *. Accordingly, the deletion of glycine at position 195 is designated as “Gly195*” or “G195*”. Multiple deletions are separated by addition marks (“+”), e.g., “Gly195*+Ser411*” or “G195*+S411*”.

Insertions: For an amino acid insertion, the following nomenclature is used: Original amino acid, position, original amino acid, inserted amino acid. Accordingly the insertion of lysine after glycine at position 195 is designated “Gly195GlyLys” or “G195GK”. An insertion of multiple amino acids is designated [Original amino acid, position, original amino acid, inserted amino acid #1, inserted amino acid #2; etc.]. For example, the insertion of lysine and alanine after glycine at position 195 is indicated as “Gly195GlyLysAla” or “G195GKA”.

In such cases, the inserted amino acid residue(s) are numbered by the addition of lower case letters to the position number of the amino acid residue preceding the inserted amino acid residue(s). In the above example, the sequence would thus be:

| Parent | Variant |
|---|---|
| 195 | 195 195a 195b |
| G | G - K - A |

Multiple alterations: Variants comprising multiple alterations are separated by addition marks (“+”), e.g., “Arg170Tyr+Gly195Glu” or “R170Y+G195E” representing a substitution of arginine and glycine at positions 170 and 195 with tyrosine and glutamic acid, respectively.

Different alterations: Where different alterations can be introduced at a position, the different alterations are separated by a comma, e.g., “Arg170Tyr,Glu” represents a substitution of arginine at position 170 with tyrosine or glutamic acid. Thus, “Tyr167Gly,Ala+Arg170Gly,Ala” designates the following variants: “Tyr167Gly+Arg170Gly”, “Tyr167Gly+Arg170Ala”, “Tyr167Ala+Arg170Gly”, and “Tyr167Ala+Arg170Ala”.

### DETAILED DESCRIPTION OF THE INVENTION

### Polypeptides Having Beta-Glucanase Activity

This invention provides the use of novel beta-glucanases and one or more amylases for cleaning or detergent compositions which have a benefit in removing stains and which can be used in cleaning or detergent applications or for processes such as cleaning hard-surfaces, dish wash and laundering.

The invention also provides the use of beta-glucanases that are wash stable in detergent formulations in the presence of amylases and/or proteases. The beta-glucanases of the invention show good storage stability in detergent formulations containing amylases and optionally proteases and furthermore show improved storage stability over cellulases in detergent formulations containing amylases and optionally proteases. The storage stability of the beta-glucanase can be tested by measuring the activity in the AZCL-beta-glucan assay or alternatively in the wash assay (example 2). The storage stability can be performed using different conditions, such as different detergent compositions, and at different temperatures, such as at 4° C., 25° C., 30° C. and/or 37° C., and can be tested after different time periods, such as after 2, 4, 6 and/or 8 weeks.

In one embodiment, the invention concerns a cleaning or detergent composition comprising a beta-glucanase selected from the group consisting of:
(a) a polypeptide having at least 80%, at least 81%, least 82%, at least 83%, at least 84%, at least 85%, at least 86%, at least 87%, at least 88%, at least 89%, least 90%, at least 91%, least 92%, at least 93%, at least 94%, at least 95%, at least 96%, at least 97%, at least 98%, at least 99%, or 100% sequence identity to the mature polypeptide of SEQ ID NO: 2;
(b) a polypeptide encoded by a polynucleotide that hybridizes under medium stringency conditions, medium-high stringency conditions, high stringency conditions, or very high stringency conditions with the mature polypeptide coding sequence of SEQ ID NO: 1 or the full-length complement thereof;
(c) a polypeptide encoded by a polynucleotide having at least 80%, at least 81%, least 82%, at least 83%, at least 84%, at least 85%, at least 86%, at least 87%, at least 88%, at least 89%, least 90%, at least 91%, least 92%, at least 93%, at least 94%, at least 95%, at least 96%, at least 97%, at least 98%, at least 99%, or 100% sequence identity to the mature polypeptide coding sequence of SEQ ID NO: 1;
(d) a variant of the mature polypeptide of SEQ ID NO: 2 comprising a substitution, deletion, and/or insertion at one or more positions; and
(e) a fragment of the polypeptide of (a), (b), (c), or (d) that has beta-glucanase activity; and one or more amylases, where the cleaning or detergent composition show good storage stability at different temperatures, such as at 4° C., 25° C., 30° C. and/or 37° C., and can be tested after different time periods, such as after 2, 4, 6 and/or 8 weeks.

In one embodiment, the present invention relates to a cleaning or detergent composition comprising a beta-glucanase having at least 80% sequence identity to the mature polypeptide of SEQ ID NO: 2 and one or more amylases.

An embodiment of the invention is a cleaning or detergent composition comprising a beta-glucanase having at least 81% sequence identity to the mature polypeptide of SEQ ID NO: 2 and one or more amylases.

An embodiment of the invention is a cleaning or detergent composition comprising a beta-glucanase having at least 82% sequence identity to the mature polypeptide of SEQ ID NO: 2 and one or more amylases.

An embodiment of the invention is a cleaning or detergent composition comprising a beta-glucanase having at least 83% sequence identity to the mature polypeptide of SEQ ID NO: 2 and one or more amylases.

An embodiment of the invention is a cleaning or detergent composition comprising a beta-glucanase having at least 84% sequence identity to the mature polypeptide of SEQ ID NO: 2 and one or more amylases.

An embodiment of the invention is a cleaning or detergent composition comprising a beta-glucanase having at least 85% sequence identity to the mature polypeptide of SEQ ID NO: 2 and one or more amylases.

An embodiment of the invention is a cleaning or detergent composition comprising a beta-glucanase having at least 86% sequence identity to the mature polypeptide of SEQ ID NO: 2 and one or more amylases.

An embodiment of the invention is a cleaning or detergent composition comprising a beta-glucanase having at least 87% sequence identity to the mature polypeptide of SEQ ID NO: 2 and one or more amylases.

An embodiment of the invention is a cleaning or detergent composition comprising a beta-glucanase having at least 88% sequence identity to the mature polypeptide of SEQ ID NO: 2 and one or more amylases.

An embodiment of the invention is a cleaning or detergent composition comprising a beta-glucanase having at least 89% sequence identity to the mature polypeptide of SEQ ID NO: 2 and one or more amylases.

An embodiment of the invention is a cleaning or detergent composition comprising a beta-glucanase having at least 90% sequence identity to the mature polypeptide of SEQ ID NO: 2 and one or more amylases.

An embodiment of the invention is a cleaning or detergent composition comprising a beta-glucanase having at least 91% sequence identity to the mature polypeptide of SEQ ID NO: 2 and one or more amylases.

An embodiment of the invention is a cleaning or detergent composition comprising a beta-glucanase having at least 92% sequence identity to the mature polypeptide of SEQ ID NO: 2 and one or more amylases.

An embodiment of the invention is a cleaning or detergent composition comprising a beta-glucanase having at least 93% sequence identity to the mature polypeptide of SEQ ID NO: 2 and one or more amylases.

An embodiment of the invention is a cleaning or detergent composition comprising a beta-glucanase having at least 94% sequence identity to the mature polypeptide of SEQ ID NO: 2 and one or more amylases.

An embodiment of the invention is a cleaning or detergent composition comprising a beta-glucanase having at least 95% sequence identity to the mature polypeptide of SEQ ID NO: 2 and one or more amylases.

An embodiment of the invention is a cleaning or detergent composition comprising a beta-glucanase having at least 96% sequence identity to the mature polypeptide of SEQ ID NO: 2 and one or more amylases.

An embodiment of the invention is a cleaning or detergent composition comprising a beta-glucanase having at least 97% sequence identity to the mature polypeptide of SEQ ID NO: 2 and one or more amylases.

An embodiment of the invention is a cleaning or detergent composition comprising a beta-glucanase having at least 98% sequence identity to the mature polypeptide of SEQ ID NO: 2 and one or more amylases.

An embodiment of the invention is a cleaning or detergent composition comprising a beta-glucanase having at least 99% sequence identity to the mature polypeptide of SEQ ID NO: 2 and one or more amylases.

An embodiment of the invention is a cleaning or detergent composition comprising a beta-glucanase having at least 81% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 82% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 83% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 84% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 85% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 86% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 87% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 88% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 89% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 90% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 91% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 92% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 93% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 94% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 95% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 96% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 97% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 98% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 99% sequence identity to the mature polypeptide of SEQ ID NO: 2 and an alpha-amylase having at least 90% sequence identity to SEQ ID NO: 11.

An embodiment of the invention is a cleaning or detergent composition comprising a beta-glucanase having at least 81% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 82% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 83% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 84% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 85% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 86% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 87% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 88% sequence identity to the mature polypeptide of SEQ ID NO: 2, and an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 89% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 90% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 91% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 92% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 93% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 94% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 95% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 96% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 97% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 98% sequence identity to the mature polypeptide of SEQ ID NO: 2, an alpha-amylase having at least 90% sequence identity to SEQ ID NO: 11 and a protease having at least 90% sequence identity to SEQ ID NO: 13.

An embodiment of the invention is a cleaning or detergent composition comprising a beta-glucanase having at least 99% sequence identity to the mature polypeptide of SEQ ID NO: 2, an alpha-amylase having at least 90% sequence identity to SEQ ID NO: 11, and a protease having at least 90% sequence identity to SEQ ID NO: 13.

In one aspect, the beta-glucanase differs by no more than 42 amino acids, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41 or 42 amino acids from the mature polypeptide of SEQ ID NO: 2. An embodiment is a cleaning or detergent composition comprising a beta-glucanase and one or more amylases.

A beta-glucanase of the present invention preferably comprises or consists of the amino acid sequence of SEQ ID NO: 2 or an allelic variant thereof; or is a fragment thereof having beta-glucanase activity. In another aspect, the beta-glucanase comprises or consists of the mature polypeptide of SEQ ID NO: 2. In another aspect, the beta-glucanase comprises or consists of amino acids 1 to 214 of SEQ ID NO: 2. An embodiment is a cleaning or detergent composition comprising a beta-glucanase and one or more amylases.

An embodiment is a cleaning or detergent composition comprising a beta-glucanase of the invention, one or more amylases and optionally one or more further enzymes selected from the group comprising of proteases, lipases, cutinases, cellulases, endoglucanases, xyloglucanases, pectinases, pectin lyases, xanthanases, peroxidaes, haloperoxygenases, catalases, mannanases, or any mixture thereof having an enzyme detergency benefit in cleaning or detergent applications. A further embodiment of the invention is the cleaning or detergent composition having an enzyme detergency benefit on oat stains, such as chocolate/porridge oat stains or cocoa/oat flake stains.

An embodiment is a cleaning or detergent composition comprising a beta-glucanase of the invention, one or more amylases and optionally one or more further enzymes selected from the group comprising of proteases, lipases, cutinases, cellulases, endoglucanases, xyloglucanases, pectinases, pectin lyases, xanthanases, peroxidaes, haloperoxygenases, catalases, mannanases, or any mixture thereof having an improved wash performance in cleaning or detergent applications. A further embodiment is the cleaning or detergent having an improved wash performance on e.g. chocolate/porridge oat stains or cocoa/oat flake stains.

An embodiment is a cleaning or detergent composition comprising a beta-glucanase of the invention, one or more amylases, one or more proteases and optionally one or more further enzymes selected from the group comprising of lipases, cutinases, cellulases, endoglucanases, xyloglucanases, pectinases, pectin lyases, xanthanases, peroxidaes, haloperoxygenases, catalases, mannanases, or any mixture thereof having an enzyme detergency benefit in cleaning or detergent applications. A further embodiment of the invention is the cleaning or detergent composition having an enzyme detergency benefit on oat stains, such as chocolate/porridge oat stains or cocoa/oat flake stains.

An embodiment is a cleaning or detergent composition comprising a beta-glucanase of the invention, one or more amylases, one or more proteases and optionally one or more further enzymes selected from the group comprising of lipases, cutinases, cellulases, endoglucanases, xyloglucanases, pectinases, pectin lyases, xanthanases, peroxidaes, haloperoxygenases, catalases, mannanases, or any mixture thereof having an improved wash performance in cleaning or detergent applications. A further embodiment is the cleaning or detergent having an improved wash performance on e.g. chocolate/porridge oat stains or cocoa/oat flake stains.

In another aspect, the invention relates to the use of a beta-glucanase having at least 80%, at least 81%, least 82%, at least 83%, at least 84%, at least 85%, at least 86%, at least 87%, at least 88%, at least 89%, least 90%, at least 91%, least 92%, at least 93%, at least 94%, at least 95%, at least 96%, at least 97%, at least 98%, at least 99%, or 100% sequence identity to the mature polypeptide of SEQ ID NO: 2 and one or more amylase for dish wash or laundering.

In a further embodiment, the present invention relates to a cleaning or detergent composition comprising a polypeptide encoded by a polynucleotide that hybridizes under medium stringency conditions, medium-high stringency conditions, high stringency conditions, or very high stringency conditions with the mature polypeptide coding sequence of SEQ ID NO: 1 or the full-length complement thereof and one or more amylases (Sambrook et al., 1989, Molecular Cloning, A Laboratory Manual, 2d edition, Cold Spring Harbor, N.Y.).

The polynucleotide of SEQ ID NO: 1 or a subsequence thereof, as well as the polypeptide of SEQ ID NO: 2 or a fragment thereof, may be used to design nucleic acid probes to identify and clone DNA encoding polypeptides having beta-glucanase from strains of different genera or species according to methods well known in the art. In particular, such probes can be used for hybridization with the genomic DNA or cDNA of a cell of interest, following standard Southern blotting procedures, in order to identify and isolate the corresponding gene therein. Such probes can be considerably shorter than the entire sequence, but should be at least 15, e.g., at least 25, at least 35, or at least 70 nucleotides in length. Preferably, the nucleic acid probe is at least 100 nucleotides in length, e.g., at least 200 nucleotides, at least 300 nucleotides, at least 400 nucleotides, at least 500 nucleotides, at least 600 nucleotides, at least 700 nucleotides, at least 800 nucleotides, or at least 900 nucleotides in length. Both DNA and RNA probes can be used. The probes are typically labelled for detecting the corresponding gene (for example, with ³²P, ³H, ³⁵S, biotin, or avidin). Such probes are encompassed by the present invention.

A genomic DNA or cDNA library prepared from such other strains may be screened for DNA that hybridizes with the probes described above and encodes a polypeptide having beta-glucanase activity. Genomic or other DNA from such other strains may be separated by agarose or polyacrylamide gel electrophoresis, or other separation techniques. DNA from the libraries or the separated DNA may be transferred to and immobilized on nitrocellulose or other suitable carrier material. In order to identify a clone or DNA that hybridizes with SEQ ID NO: 1 or a subsequence thereof, the carrier material is used in a Southern blot.

For purposes of the present invention, hybridization indicates that the polynucleotide hybridizes to a labelled nucleic acid probe corresponding to (i) SEQ ID NO: 1 (ii) the mature polypeptide coding sequence of SEQ ID NO: 1 (iii) the full-length complement thereof; or (iv) a subsequence thereof, under medium to very high stringency conditions. Molecules to which the nucleic acid probe hybridizes under these conditions can be detected using, for example, X-ray film or any other detection means known in the art.

In one aspect, the nucleic acid probe is a polynucleotide that encodes the polypeptide of SEQ ID NO: 2; the mature polypeptide thereof; or a fragment thereof. In another aspect, the nucleic acid probe is SEQ ID NO: 1.

In another embodiment, the present invention relates to a cleaning or detergent composition comprising a polypeptide encoded by a polynucleotide having a sequence identity to the mature polypeptide coding sequence of SEQ ID NO: 1 of at least 80%, at least 81%, least 82%, at least 83%, at least 84%, at least 85%, at least 86%, at least 87%, at least 88%, at least 89%, least 90%, at least 91%, least 92%, at least 93%, at least 94%, at least 95%, at least 96%, at least 97%, at least 98%, at least 99% or 100% and one or more amylases.

In another embodiment, the present invention relates to a cleaning or detergent composition comprising a variant of the mature polypeptide of SEQ ID NO: 2 and one or more amylases, wherein the variant comprises a substitution, deletion, and/or insertion at one or more (e.g., several) positions. In an embodiment, the number of amino acid substitutions, deletions and/or insertions introduced into the mature polypeptide of SEQ ID NO: 2 is not more than 42, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, or 41. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding domain.

Examples of conservative substitutions are within the groups of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. Common substitutions are Ala/Ser, Val/Ile, Asp/Glu, Thr/Ser, Ala/Gly, Ala/Thr, Ser/Asn, AlaNal, Ser/Gly, Tyr/Phe, Ala/Pro, Lys/Arg, Asp/Asn, Leu/Ile, Leu/Val, Ala/Glu, and Asp/Gly.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in a polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for beta-glucanase activity to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labelling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identity of essential amino acids can also be inferred from an alignment with a related polypeptide.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochemistry 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

The polypeptide may be a hybrid polypeptide in which a region of one polypeptide is fused at the N-terminus or the C-terminus of a region of another polypeptide.

The polypeptide may be a fusion polypeptide or cleavable fusion polypeptide in which another polypeptide is fused at the N-terminus or the C-terminus of the polypeptide of the present invention. A fusion polypeptide is produced by fusing a polynucleotide encoding another polypeptide to a polynucleotide of the present invention. Techniques for producing fusion polypeptides are known in the art, and include ligating the coding sequences encoding the polypeptides so that they are in frame and that expression of the fusion polypeptide is under control of the same promoter(s) and terminator. Fusion polypeptides may also be constructed using intein technology in which fusion polypeptides are created post-translationally (Cooper et al., 1993, EMBO J. 12: 2575-2583; Dawson et al., 1994, Science 266: 776-779).

A fusion polypeptide can further comprise a cleavage site between the two polypeptides. Upon secretion of the fusion protein, the site is cleaved releasing the two polypeptides. Examples of cleavage sites include, but are not limited to, the sites disclosed in Martin et al., 2003, J. Ind. Microbiol. Biotechnol. 3: 568-576; Svetina et al., 2000, J. Biotechnol. 76: 245-251; Rasmussen-Wilson et al., 1997, Appl. Environ. Microbiol. 63: 3488-3493; Ward et al., 1995, Biotechnology 13: 498-503; and Contreras et al., 1991, Biotechnology 9: 378-381; Eaton et al., 1986, Biochemistry 25: 505-512; Collins-Racie et al., 1995, Biotechnology 13: 982-987; Carter et al., 1989, Proteins: Structure, Function, and Genetics 6: 240-248; and Stevens, 2003, Drug Discovery World 4: 35-48.

The polypeptide may be expressed by a recombinant DNA sequence containing the coding for a His-tag or HQ-tag to give, after any post-translational modifications, the mature polypeptide containing all or part of the His- or HQ-tag. The HQ-tag, having the sequence —RHQHQHQ, may be fully or partly cleaved off the polypeptide during the post-translational modifications resulting in for example the additional amino acids —RHQHQ attached to the N-terminal of the mature polypeptide. The His-tag, having the sequence —RPHHHHHH, may be fully or partly cleaved off the polypeptide during the post-translational modifications resulting in, for example, the additional amino acids —RPHHHHH or —RPHHHH attached to the N-terminal of the mature polypeptide.

Sources of Polypeptides having Beta-Glucanase Activity

A beta-glucanase of the present invention may be obtained from microorganisms of any genus. For purposes of the present invention, the term “obtained from” as used herein in connection with a given source shall mean that the polypeptide encoded by a polynucleotide is produced by the source or by a strain in which the polynucleotide from the source has been inserted. In one aspect, the polypeptide obtained from a given source is secreted extracellularly.

The polypeptide may be a bacterial polypeptide. For example, the polypeptide may be a Gram-positive bacterial polypeptide such as a Bacillus, Clostridium, Enterococcus, Geobacillus, Lactobacillus, Lactococcus, Oceanobacillus, Staphylococcus, Streptococcus, or Streptomyces polypeptide having [enzyme] activity, or a Gram-negative bacterial polypeptide such as a Campylobacter, E. coli, Flavobacterium, Fusobacterium, Helicobacter, Ilyobacter, Neisseria, Pseudomonas, Salmonella, or Ureaplasma polypeptide.

In one aspect, the polypeptide is a Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, or Bacillus thuringiensis polypeptide.

It will be understood that for the aforementioned species, the invention encompasses both the perfect and imperfect states, and other taxonomic equivalents, e.g., anamorphs, regardless of the species name by which they are known. Those skilled in the art will readily recognize the identity of appropriate equivalents.

Strains of these species are readily accessible to the public in a number of culture collections, such as the American Type Culture Collection (ATCC), Deutsche Sammlung von Mikroorganismen and Zellkulturen GmbH (DSMZ), Centraalbureau Voor Schimmelcultures (CBS), and Agricultural Research Service Patent Culture Collection, Northern Regional Research Center (NRRL).

The polypeptide may be identified and obtained from other sources including microorganisms isolated from nature (e.g., soil, composts, water, etc.) or DNA samples obtained directly from natural materials (e.g., soil, composts, water, etc.) using the above-mentioned probes. Techniques for isolating microorganisms and DNA directly from natural habitats are well known in the art. A polynucleotide encoding the polypeptide may then be obtained by similarly screening a genomic DNA or cDNA library of another microorganism or mixed DNA sample. Once a polynucleotide encoding a polypeptide has been detected with the probe(s), the polynucleotide can be isolated or cloned by utilizing techniques that are known to those of ordinary skill in the art (see, e.g., Sambrook et al., 1989, supra).

### Polynucleotides

The present invention also relates to isolated polynucleotides encoding a polypeptide of the present invention, as described herein.

The techniques used to isolate or clone a polynucleotide are known in the art and include isolation from genomic DNA or cDNA, or a combination thereof. The cloning of the polynucleotides from genomic DNA can be effected, e.g., by using the well-known polymerase chain reaction (PCR) or antibody screening of expression libraries to detect cloned DNA fragments with shared structural features. See, e.g., Innis et al., 1990, PCR: A Guide to Methods and Application, Academic Press, New York. Other nucleic acid amplification procedures such as ligase chain reaction (LCR), ligation activated transcription (LAT) and polynucleotide-based amplification (NASBA) may be used. The polynucleotides may be cloned in a strain of Bacillus subtilis or E. Coli, or a related organism and thus, for example, may be an allelic or species variant of the polypeptide encoding region of the polynucleotide.

Modification of a polynucleotide encoding a polypeptide of the present invention may be necessary for synthesizing polypeptides substantially similar to the polypeptide. The term “substantially similar” to the polypeptide refers to non-naturally occurring forms of the polypeptide. These polypeptides may differ in some engineered way from the polypeptide isolated from its native source, e.g., variants that differ in specific activity, thermostability, pH optimum, or the like. The variants may be constructed on the basis of the polynucleotide presented as the mature polypeptide coding sequence of SEQ ID NO: 1 or SEQ ID NO:3, a subsequence thereof, and/or by introduction of nucleotide substitutions that do not result in a change in the amino acid sequence of the polypeptide, but which correspond to the codon usage of the host organism intended for production of the enzyme, or by introduction of nucleotide substitutions that may give rise to a different amino acid sequence. For a general description of nucleotide substitution, see Ford et al., (1991), “Protein Expression and Purification”, 2: 95-107.

### Nucleic Acid Constructs

The present invention also relates to nucleic acid constructs comprising a polynucleotide of the present invention operably linked to one or more control sequences that direct the expression of the coding sequence in a suitable host cell under conditions compatible with the control sequences.

A polynucleotide may be manipulated in a variety of ways to provide for expression of the polypeptide. Manipulation of the polynucleotide prior to its insertion into a vector may be desirable or necessary depending on the expression vector. The techniques for modifying polynucleotides utilizing recombinant DNA methods are well known in the art.

The control sequence may be a promoter, a polynucleotide that is recognized by a host cell for expression of a polynucleotide encoding a polypeptide of the present invention. The promoter contains transcriptional control sequences that mediate the expression of the polypeptide. The promoter may be any polynucleotide that shows transcriptional activity in the host cell including mutant, truncated, and hybrid promoters, and may be obtained from genes encoding extracellular or intracellular polypeptides either homologous or heterologous to the host cell.

Examples of suitable promoters for directing transcription of the nucleic acid constructs of the present invention in a bacterial host cell are the promoters obtained from the Bacillus amyloliquefaciens alpha-amylase gene (amyQ), Bacillus licheniformis alpha-amylase gene (amyL), Bacillus licheniformis penicillinase gene (penP), Bacillus stearothermophilus maltogenic amylase gene (amyM), Bacillus subtilis levansucrase gene (sacB), Bacillus subtilis xylA and xylB genes, Bacillus thuringiensis cryIIIA gene (Agaisse and Lereclus, 1994, Molecular Microbiology 13: 97-107), E. coli lac operon, E. coli trc promoter (Egon et al., 1988, Gene 69: 301-315), Streptomyces coelicolor agarase gene (dagA), and prokaryotic beta-lactamase gene (Villa-Kamaroff et al., 1978, Proc. Natl. Acad. Sci. USA 75: 3727-3731), as well as the tac promoter (DeBoer et al., 1983, Proc. Natl. Acad. Sci. USA 80: 21-25). Further promoters are described in “Useful proteins from recombinant bacteria” in Gilbert et al., 1980, Scientific American 242: 74-94; and in Sambrook et al., 1989, supra. Examples of tandem promoters are disclosed in WO 99/43835.

Examples of suitable promoters for directing transcription of the nucleic acid constructs of the present invention in a filamentous fungal host cell are promoters obtained from the genes for Aspergillus nidulans acetamidase, Aspergillus niger neutral alpha-amylase, Aspergillus niger acid stable alpha-amylase, Aspergillus niger or Aspergillus awamori glucoamylase (glaA), Aspergillus oryzae TAKA amylase, Aspergillus oryzae alkaline protease, Aspergillus oryzae triose phosphate isomerase, Fusarium oxysporum trypsin-like protease (WO 96/00787), Fusarium venenatum amyloglucosidase (WO 00/56900), Fusarium venenatum Dania (WO 00/56900), Fusarium venenatum Quinn (WO 00/56900), Rhizomucor miehei lipase, Rhizomucor miehei aspartic proteinase, Trichoderma reesei beta-glucosidase, Trichoderma reesei cellobiohydrolase I, Trichoderma reesei cellobiohydrolase II, Trichoderma reesei endoglucanase I, Trichoderma reesei endoglucanase II, Trichoderma reesei endoglucanase III, Trichoderma reesei endoglucanase IV, Trichoderma reesei endoglucanase V, Trichoderma reesei xylanase I, Trichoderma reesei xylanase II, Trichoderma reesei beta-xylosidase, as well as the NA2-tpi promoter (a modified promoter from an Aspergillus neutral alpha-amylase gene in which the untranslated leader has been replaced by an untranslated leader from an Aspergillus triose phosphate isomerase gene; non-limiting examples include modified promoters from an Aspergillus niger neutral alpha-amylase gene in which the untranslated leader has been replaced by an untranslated leader from an Aspergillus nidulans or Aspergillus oryzae triose phosphate isomerase gene); and mutant, truncated, and hybrid promoters thereof.

In a yeast host, useful promoters are obtained from the genes for Saccharomyces cerevisiae enolase (ENO-1), Saccharomyces cerevisiae galactokinase (GAL1), Saccharomyces cerevisiae alcohol dehydrogenase/glyceraldehyde-3-phosphate dehydrogenase (ADH1, ADH2/GAP), Saccharomyces cerevisiae triose phosphate isomerase (TPI), Saccharomyces cerevisiae metallothionein (CUP1), and Saccharomyces cerevisiae 3-phosphoglycerate kinase. Other useful promoters for yeast host cells are described by Romanos et al., 1992, Yeast 8: 423-488.

The control sequence may also be a transcription terminator, which is recognized by a host cell to terminate transcription. The terminator is operably linked to the 3′-terminus of the polynucleotide encoding the polypeptide. Any terminator that is functional in the host cell may be used in the present invention.

Preferred terminators for bacterial host cells are obtained from the genes for Bacillus clausii alkaline protease (aprH), Bacillus licheniformis alpha-amylase (amyL), and Escherichia coli ribosomal RNA (rrnB).

Preferred terminators for filamentous fungal host cells are obtained from the genes for Aspergillus nidulans anthranilate synthase, Aspergillus niger glucoamylase, Aspergillus niger alpha-glucosidase, Aspergillus oryzae TAKA amylase, and Fusarium oxysporum trypsin-like protease.

Preferred terminators for yeast host cells are obtained from the genes for Saccharomyces cerevisiae enolase, Saccharomyces cerevisiae cytochrome C (CYC1), and Saccharomyces cerevisiae glyceraldehyde-3-phosphate dehydrogenase. Other useful terminators for yeast host cells are described by Romanos et al., 1992, supra.

The control sequence may also be an mRNA stabilizer region downstream of a promoter and upstream of the coding sequence of a gene which increases expression of the gene.

Examples of suitable mRNA stabilizer regions are obtained from a Bacillus thuringiensis cryIIIA gene (WO 94/25612) and a Bacillus subtilis SP82 gene (Hue et al., 1995, Journal of Bacteriology 177: 3465-3471).

The control sequence may also be a leader, a nontranslated region of an mRNA that is important for translation by the host cell. The leader is operably linked to the 5′-terminus of the polynucleotide encoding the polypeptide. Any leader that is functional in the host cell may be used.

Preferred leaders for filamentous fungal host cells are obtained from the genes for Aspergillus oryzae TAKA amylase and Aspergillus nidulans triose phosphate isomerase.

Suitable leaders for yeast host cells are obtained from the genes for Saccharomyces cerevisiae enolase (ENO-1), Saccharomyces cerevisiae 3-phosphoglycerate kinase, Saccharomyces cerevisiae alpha-factor, and Saccharomyces cerevisiae alcohol dehydrogenase/glyceraldehyde-3-phosphate dehydrogenase (ADH2/GAP).

The control sequence may also be a polyadenylation sequence, a sequence operably linked to the 3′-terminus of the polynucleotide and, when transcribed, is recognized by the host cell as a signal to add polyadenosine residues to transcribed mRNA. Any polyadenylation sequence that is functional in the host cell may be used.

Preferred polyadenylation sequences for filamentous fungal host cells are obtained from the genes for Aspergillus nidulans anthranilate synthase, Aspergillus niger glucoamylase, Aspergillus niger alpha-glucosidase Aspergillus oryzae TAKA amylase, and Fusarium oxysporum trypsin-like protease.

Useful polyadenylation sequences for yeast host cells are described by Guo and Sherman, 1995, Mol. Cellular Biol. 15: 5983-5990.

The control sequence may also be a signal peptide coding region that encodes a signal peptide linked to the N-terminus of a polypeptide and directs the polypeptide into the cell's secretory pathway. The 5′-end of the coding sequence of the polynucleotide may inherently contain a signal peptide coding sequence naturally linked in translation reading frame with the segment of the coding sequence that encodes the polypeptide. Alternatively, the 5′-end of the coding sequence may contain a signal peptide coding sequence that is foreign to the coding sequence. A foreign signal peptide coding sequence may be required where the coding sequence does not naturally contain a signal peptide coding sequence. Alternatively, a foreign signal peptide coding sequence may simply replace the natural signal peptide coding sequence in order to enhance secretion of the polypeptide. However, any signal peptide coding sequence that directs the expressed polypeptide into the secretory pathway of a host cell may be used.

Effective signal peptide coding sequences for bacterial host cells are the signal peptide coding sequences obtained from the genes for Bacillus NCIB 11837 maltogenic amylase, Bacillus licheniformis subtilisin, Bacillus licheniformis beta-lactamase, Bacillus stearothermophilus alpha-amylase, Bacillus stearothermophilus neutral proteases (nprT, nprS, nprM), and Bacillus subtilis prsA. Further signal peptides are described by Simonen and Palva, (1993), Microbiological Reviews 57: 109-137.

Effective signal peptide coding sequences for filamentous fungal host cells are the signal peptide coding sequences obtained from the genes for Aspergillus niger neutral amylase, Aspergillus niger glucoamylase, Aspergillus oryzae TAKA amylase, Humicola insolens cellulase, Humicola insolens endoglucanase V, Humicola lanuginosa lipase, and Rhizomucor miehei aspartic proteinase.

Useful signal peptides for yeast host cells are obtained from the genes for Saccharomyces cerevisiae alpha-factor and Saccharomyces cerevisiae invertase. Other useful signal peptide coding sequences are described by Romanos et al., 1992, supra.

The control sequence may also be a propeptide coding sequence that encodes a propeptide positioned at the N-terminus of a polypeptide. The resultant polypeptide is known as a proenzyme or propolypeptide (or a zymogen in some cases). A propolypeptide is generally inactive and can be converted to an active polypeptide by catalytic or autocatalytic cleavage of the propeptide from the propolypeptide. The propeptide coding sequence may be obtained from the genes for Bacillus subtilis alkaline protease (aprE), Bacillus subtilis neutral protease (nprT), Myceliophthora thermophila laccase (WO 95/33836), Rhizomucor miehei aspartic proteinase, and Saccharomyces cerevisiae alpha-factor.

Where both signal peptide and propeptide sequences are present, the propeptide sequence is positioned next to the N-terminus of a polypeptide and the signal peptide sequence is positioned next to the N-terminus of the propeptide sequence.

It may also be desirable to add regulatory sequences that regulate expression of the polypeptide relative to the growth of the host cell. Examples of regulatory systems are those that cause expression of the gene to be turned on or off in response to a chemical or physical stimulus, including the presence of a regulatory compound. Regulatory systems in prokaryotic systems include the lac, tac, and trp operator systems. In yeast, the ADH2 system or GAL1 system may be used. In filamentous fungi, the Aspergillus niger glucoamylase promoter, Aspergillus oryzae TAKA alpha-amylase promoter, and Aspergillus oryzae glucoamylase promoter may be used. Other examples of regulatory sequences are those that allow for gene amplification. In eukaryotic systems, these regulatory sequences include the dihydrofolate reductase gene that is amplified in the presence of methotrexate, and the metallothionein genes that are amplified with heavy metals. In these cases, the polynucleotide encoding the polypeptide would be operably linked with the regulatory sequence.

### Expression Vectors

The present invention also relates to recombinant expression vectors comprising a polynucleotide of the present invention, a promoter, and transcriptional and translational stop signals. The various nucleotide and control sequences may be joined together to produce a recombinant expression vector that may include one or more convenient restriction sites to allow for insertion or substitution of the polynucleotide encoding the polypeptide at such sites. Alternatively, the polynucleotide may be expressed by inserting the polynucleotide or a nucleic acid construct comprising the polynucleotide into an appropriate vector for expression. In creating the expression vector, the coding sequence is located in the vector so that the coding sequence is operably linked with the appropriate control sequences for expression.

The recombinant expression vector may be any vector (e.g., a plasmid or virus) that can be conveniently subjected to recombinant DNA procedures and can bring about expression of the polynucleotide. The choice of the vector will typically depend on the compatibility of the vector with the host cell into which the vector is to be introduced. The vector may be a linear or closed circular plasmid.

The vector may be an autonomously replicating vector, i.e., a vector that exists as an extrachromosomal entity, the replication of which is independent of chromosomal replication, e.g., a plasmid, an extrachromosomal element, a minichromosome, or an artificial chromosome. The vector may contain any means for assuring self-replication. Alternatively, the vector may be one that, when introduced into the host cell, is integrated into the genome and replicated together with the chromosome(s) into which it has been integrated. Furthermore, a single vector or plasmid or two or more vectors or plasmids that together contain the total DNA to be introduced into the genome of the host cell, or a transposon, may be used.

The vector preferably contains one or more selectable markers that permit easy selection of transformed, transfected, transduced, or the like cells. A selectable marker is a gene the product of which provides for biocide or viral resistance, resistance to heavy metals, prototrophy to auxotrophs, and the like.

Examples of bacterial selectable markers are Bacillus licheniformis or Bacillus subtilis dal genes, or markers that confer antibiotic resistance such as ampicillin, chloramphenicol, kanamycin, neomycin, spectinomycin, or tetracycline resistance. Suitable markers for yeast host cells include, but are not limited to, ADE2, HIS3, LEU2, LYS2, MET3, TRP1, and URA3. Selectable markers for use in a filamentous fungal host cell include, but are not limited to, amdS (acetamidase), argB (ornithine carbamoyltransferase), bar (phosphinothricin acetyltransferase), hph (hygromycin phosphotransferase), niaD (nitrate reductase), pyrG (orotidine-5′-phosphate decarboxylase), sC (sulfate adenyltransferase), and trpC (anthranilate synthase), as well as equivalents thereof. Preferred for use in an Aspergillus cell are Aspergillus nidulans or Aspergillus oryzae amdS and pyrG genes and a Streptomyces hygroscopicus bar gene.

The vector preferably contains an element(s) that permits integration of the vector into the host cell's genome or autonomous replication of the vector in the cell independent of the genome.

For integration into the host cell genome, the vector may rely on the polynucleotide's sequence encoding the polypeptide or any other element of the vector for integration into the genome by homologous or non-homologous recombination. Alternatively, the vector may contain additional polynucleotides for directing integration by homologous recombination into the genome of the host cell at a precise location(s) in the chromosome(s). To increase the likelihood of integration at a precise location, the integrational elements should contain a sufficient number of nucleic acids, such as 100 to 10,000 base pairs, 400 to 10,000 base pairs, and 800 to 10,000 base pairs, which have a high degree of sequence identity to the corresponding target sequence to enhance the probability of homologous recombination. The integrational elements may be any sequence that is homologous with the target sequence in the genome of the host cell. Furthermore, the integrational elements may be non-encoding or encoding polynucleotides. On the other hand, the vector may be integrated into the genome of the host cell by non-homologous recombination.

For autonomous replication, the vector may further comprise an origin of replication enabling the vector to replicate autonomously in the host cell in question. The origin of replication may be any plasmid replicator mediating autonomous replication that functions in a cell. The term “origin of replication” or “plasmid replicator” means a polynucleotide that enables a plasmid or vector to replicate in vivo.

Examples of bacterial origins of replication are the origins of replication of plasmids pBR322, pUC19, pACYC177, and pACYC184 permitting replication in E. coli, and pUB110, pE194, pTA1060, and pAMβ1 permitting replication in Bacillus.

Examples of origins of replication for use in a yeast host cell are the 2 micron origin of replication, ARS1, ARS4, the combination of ARS1 and CEN3, and the combination of ARS4 and CEN6.

Examples of origins of replication useful in a filamentous fungal cell are AMA1 and ANSI (Gems et al., 1991, Gene 98: 61-67; Cullen et al., 1987, Nucleic Acids Res. 15: 9163-9175; WO 00/24883). Isolation of the AMA1 gene and construction of plasmids or vectors comprising the gene can be accomplished according to the methods disclosed in WO 00/24883.

More than one copy of a polynucleotide of the present invention may be inserted into a host cell to increase production of a polypeptide. An increase in the copy number of the polynucleotide can be obtained by integrating at least one additional copy of the sequence into the host cell genome or by including an amplifiable selectable marker gene with the polynucleotide where cells containing amplified copies of the selectable marker gene, and thereby additional copies of the polynucleotide, can be selected for by cultivating the cells in the presence of the appropriate selectable agent.

The procedures used to ligate the elements described above to construct the recombinant expression vectors of the present invention are well known to one skilled in the art (see, e.g., Sambrook et al., 1989, supra).

### Host Cells

The present invention also relates to recombinant host cells, comprising a polynucleotide of the present invention operably linked to one or more control sequences that direct the production of a polypeptide of the present invention. A construct or vector comprising a polynucleotide is introduced into a host cell so that the construct or vector is maintained as a chromosomal integrant or as a self-replicating extra-chromosomal vector as described earlier. The term “host cell” encompasses any progeny of a parent cell that is not identical to the parent cell due to mutations that occur during replication. The choice of a host cell will to a large extent depend upon the gene encoding the polypeptide and its source.

The host cell may be any cell useful in the recombinant production of a polypeptide of the present invention, e.g., a prokaryote or a eukaryote.

The prokaryotic host cell may be any Gram-positive or Gram-negative bacterium. Gram-positive bacteria include, but are not limited to, Bacillus, Clostridium, Enterococcus, Geobacillus, Lactobacillus, Lactococcus, Oceanobacillus, Staphylococcus, Streptococcus, and Streptomyces. Gram-negative bacteria include, but are not limited to, Campylobacter, E. coli, Flavobacterium, Fusobacterium, Helicobacter, Ilyobacter, Neisseria, Pseudomonas, Salmonella, and Ureaplasma.

The bacterial host cell may be any Bacillus cell including, but not limited to, Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, and Bacillus thuringiensis cells.

The bacterial host cell may also be any Streptococcus cell including, but not limited to, Streptococcus equisimilis, Streptococcus pyogenes, Streptococcus uberis, and Streptococcus equi subsp. Zooepidemicus cells.

The bacterial host cell may also be any Streptomyces cell including, but not limited to, Streptomyces achromogenes, Streptomyces avermitilis, Streptomyces coelicolor, Streptomyces griseus, and Streptomyces lividans cells.

The introduction of DNA into a Bacillus cell may be effected by protoplast transformation (see, e.g., Chang and Cohen, 1979, Mol. Gen. Genet. 168: 111-115), competent cell transformation (see, e.g., Young and Spizizen, 1961, J. Bacteriol. 81: 823-829, or Dubnau and Davidoff-Abelson, 1971, J. Mol. Biol. 56: 209-221), electroporation (see, e.g., Shigekawa and Dower, 1988, Biotechniques 6: 742-751), or conjugation (see, e.g., Koehler and Thorne, 1987, J. Bacteriol. 169: 5271-5278). The introduction of DNA into an E. coli cell may be effected by protoplast transformation (see, e.g., Hanahan, 1983, J. Mol. Biol. 166: 557-580) or electroporation (see, e.g., Dower et al., 1988, Nucleic Acids Res. 16: 6127-6145). The introduction of DNA into a Streptomyces cell may be effected by protoplast transformation, electroporation (see, e.g., Gong et al., 2004, Folia Microbiol. (Praha) 49: 399-405), conjugation (see, e.g., Mazodier et al., 1989, J. Bacteriol. 171: 3583-3585), or transduction (see, e.g., Burke et al., 2001, Proc. Natl. Acad. Sci. USA 98: 6289-6294). The introduction of DNA into a Pseudomonas cell may be effected by electroporation (see, e.g., Choi et al., 2006, J. Microbiol. Methods 64: 391-397) or conjugation (see, e.g., Pinedo and Smets, 2005, Appl. Environ. Microbiol. 71: 51-57). The introduction of DNA into a Streptococcus cell may be effected by natural competence (see, e.g., Perry and Kuramitsu, 1981, Infect. Immun. 32: 1295-1297), protoplast transformation (see, e.g., Catt and Jollick, 1991, Microbios 68: 189-207), electroporation (see, e.g., Buckley et al., 1999, Appl. Environ. Microbiol. 65: 3800-3804), or conjugation (see, e.g., Clewell, 1981, Microbiol. Rev. 45: 409-436). However, any method known in the art for introducing DNA into a host cell can be used.

The host cell may also be a eukaryote, such as a mammalian, insect, plant, or fungal cell.

The host cell may be a fungal cell. “Fungi” as used herein includes the phyla Ascomycota, Basidiomycota, Chytridiomycota, and Zygomycota as well as the Oomycota and all mitosporic fungi (as defined by Hawksworth et al., In, Ainsworth and Bisby's Dictionary of The Fungi, 8th edition, 1995, CAB International, University Press, Cambridge, UK).

The fungal host cell may be a yeast cell. “Yeast” as used herein includes ascosporogenous yeast (Endomycetales), basidiosporogenous yeast, and yeast belonging to the Fungi Imperfecti (Blastomycetes). Since the classification of yeast may change in the future, for the purposes of this invention, yeast shall be defined as described in Biology and Activities of Yeast (Skinner, Passmore, and Davenport, editors, Soc. App. Bacteriol. Symposium Series No. 9, 1980).

The yeast host cell may be a Candida, Hansenula, Kluyveromyces, Pichia, Saccharomyces, Schizosaccharomyces, or Yarrowia cell, such as a Kluyveromyces lactis, Saccharomyces carlsbergensis, Saccharomyces cerevisiae, Saccharomyces diastaticus, Saccharomyces douglasii, Saccharomyces kluyveri, Saccharomyces norbensis, Saccharomyces oviformis, or Yarrowia lipolytica cell.

The fungal host cell may be a filamentous fungal cell. “Filamentous fungi” include all filamentous forms of the subdivision Eumycota and Oomycota (as defined by Hawksworth et al., 1995, supra). The filamentous fungi are generally characterized by a mycelial wall composed of chitin, cellulose, glucan, chitosan, mannan, and other complex polysaccharides. Vegetative growth is by hyphal elongation and carbon catabolism is obligately aerobic. In contrast, vegetative growth by yeasts such as Saccharomyces cerevisiae is by budding of a unicellular thallus and carbon catabolism may be fermentative.

The filamentous fungal host cell may be an Acremonium, Aspergillus, Aureobasidium, Bjerkandera, Ceriporiopsis, Chrysosporium, Coprinus, Coriolus, Cryptococcus, Filibasidium, Fusarium, Humicola, Magnaporthe, Mucor, Myceliophthora, Neocallimastix, Neurospora, Paecilomyces, Penicillium, Phanerochaete, Phlebia, Piromyces, Pleurotus, Schizophyllum, Talaromyces, Thermoascus, Thielavia, Tolypocladium, Trametes, or Trichoderma cell.

For example, the filamentous fungal host cell may be an Aspergillus awamori, Aspergillus foetidus, Aspergillus fumigatus, Aspergillus japonicus, Aspergillus nidulans, Aspergillus niger, Aspergillus oryzae, Bjerkandera adusta, Ceriporiopsis aneirina, Ceriporiopsis caregiea, Ceriporiopsis gilvescens, Ceriporiopsis pannocinta, Ceriporiopsis rivulosa, Ceriporiopsis subrufa, Ceriporiopsis subvermispora, Chrysosporium inops, Chrysosporium keratinophilum, Chrysosporium lucknowense, Chrysosporium merdarium, Chrysosporium pannicola, Chrysosporium queenslandicum, Chrysosporium tropicum, Chrysosporium zonatum, Coprinus cinereus, Coriolus hirsutus, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola insolens, Humicola lanuginosa, Mucor miehei, Myceliophthora thermophila, Neurospora crassa, Penicillium purpurogenum, Phanerochaete chrysosporium, Phlebia radiata, Pleurotus eryngii, Thielavia terrestris, Trametes villosa, Trametes versicolor, Trichoderma harzianum, Trichoderma koningii, Trichoderma longibrachiatum, Trichoderma reesei, or Trichoderma viride cell.

Fungal cells may be transformed by a process involving protoplast formation, transformation of the protoplasts, and regeneration of the cell wall in a manner known per se. Suitable procedures for transformation of Aspergillus and Trichoderma host cells are described in EP 238023, Yelton et al., 1984, Proc. Natl. Acad. Sci. USA 81: 1470-1474, and Christensen et al., 1988, Bio/Technology 6: 1419-1422. Suitable methods for transforming Fusarium species are described by Malardier et al., 1989, Gene 78: 147-156, and WO 96/00787. Yeast may be transformed using the procedures described by Becker and Guarente, In Abelson, J. N. and Simon, M. I., editors, Guide to Yeast Genetics and Molecular Biology, Methods in Enzymology, Volume 194, pp 182-187, Academic Press, Inc., New York; Ito et al., 1983, J. Bacteriol. 153: 163; and Hinnen et al., 1978, Proc. Natl. Acad. Sci. USA 75: 1920.

### Methods of Production

The present invention also relates to methods of producing a polypeptide of the present invention, comprising (a) cultivating a cell, which in its wild-type form produces the polypeptide, under conditions conducive for production of the polypeptide; and (b) recovering the polypeptide. In a preferred aspect, the cell is a Bacillus cell.

The present invention also relates to methods of producing a polypeptide of the present invention, comprising (a) cultivating a recombinant host cell of the present invention under conditions conducive for production of the polypeptide; and (b) recovering the polypeptide.

The host cells are cultivated in a nutrient medium suitable for production of the polypeptide using methods known in the art. For example, the cell may be cultivated by shake flask cultivation, or small-scale or large-scale fermentation (including continuous, batch, fed-batch, or solid state fermentations) in laboratory or industrial fermentors performed in a suitable medium and under conditions allowing the polypeptide to be expressed and/or isolated. The cultivation takes place in a suitable nutrient medium comprising carbon and nitrogen sources and inorganic salts, using procedures known in the art. Suitable media are available from commercial suppliers or may be prepared according to published compositions (e.g., in catalogues of the American Type Culture Collection). If the polypeptide is secreted into the nutrient medium, the polypeptide can be recovered directly from the medium. If the polypeptide is not secreted, it can be recovered from cell lysates.

The polypeptide may be detected using methods known in the art that are specific for the polypeptides such as methods for determining beta-glucanase activity. These detection methods include, but are not limited to, use of specific antibodies, formation of an enzyme product, or disappearance of an enzyme substrate. For example, an enzyme assay may be used to determine the activity of the polypeptide.

The polypeptide may be recovered using methods known in the art. For example, the polypeptide may be recovered from the nutrient medium by conventional procedures including, but not limited to, collection, centrifugation, filtration, extraction, spray-drying, evaporation, or precipitation.

The polypeptide may be purified by a variety of procedures known in the art including, but not limited to, chromatography (e.g., ion exchange, affinity, hydrophobic, chromatofocusing, and size exclusion), electrophoretic procedures (e.g., preparative isoelectric focusing), differential solubility (e.g., ammonium sulfate precipitation), SDS-PAGE, or extraction (see, e.g., Protein Purification, Janson and Ryden, editors, VCH Publishers, New York, 1989) to obtain substantially pure polypeptides.

In an alternative aspect, the polypeptide is not recovered, but rather a host cell of the present invention expressing the polypeptide is used as a source of the polypeptide.

### Cleaning or Detergent Compositions

In one embodiment, the invention is directed to cleaning or detergent compositions comprising a beta-glucanase of the present invention and one or more amylases in combination with one or more cleaning components and optionally one or more further enzymes such as proteases, lipases, cutinases, cellulases, endoglucanases, xyloglucanases, pectinases, pectin lyases, xanthanases, peroxidaes, haloperoxygenases, catalases, mannanases, or any mixture thereof. In a further embodiment, the cleaning or detergent composition comprises a beta-glucanase of the present invention together with one or more amylases, one or more proteases, one or more cleaning components and optionally one or more further enzymes such as lipases, cutinases, cellulases, endoglucanases, xyloglucanases, pectinases, pectin lyases, xanthanases, peroxidaes, haloperoxygenases, catalases, mannanases, or any mixture thereof. The choice of additional cleaning components is within the skill of the artisan and includes conventional ingredients, including the exemplary non-limiting components set forth below.

The choice of components may include, for textile care, the consideration of the type of textile to be cleaned, the type and/or degree of soiling, the temperature at which cleaning is to take place, and the formulation of the detergent product. Although the components mentioned below are categorized according to a particular function, this should not be construed as a limitation since the component may have one or more additional functionalities which the skilled artisan will appreciate.

The cleaning or detergent composition may be suitable for the laundering of textiles such as e.g. fabrics, cloths or linen, or for cleaning hard surfaces such as dish wash.

The present invention also relates to the use of beta-glucanases of the present invention and one or more amylases having an enzyme detergency benefit in cleaning or detergent applications and their use of thereof in processes such as cleaning hard surfaces and laundry. A further embodiment relates to the use of beta-glucanases of the present invention, one or more amylases and one or more further enzymes such as proteases, lipases, cutinases, cellulases, endoglucanases, xyloglucanases, pectinases, pectin lyases, xanthanases, peroxidaes, haloperoxygenases, catalases, mannanases, or any mixture thereof having an enzyme detergency benefit in cleaning or detergent applications and their use of thereof in processes such as cleaning hard surfaces and laundry. A further embodiment relates to the use of beta-glucanases of the present invention, one or more amylases, one or more proteases and one or more further enzymes such as lipases, cutinases, cellulases, endoglucanases, xyloglucanases, pectinases, pectin lyases, xanthanases, peroxidaes, haloperoxygenases, catalases, mannanases, or any mixture thereof having an enzyme detergency benefit in cleaning or detergent applications and their use of thereof in processes such as cleaning hard surfaces and laundry.

The present invention also relates to the use of beta-glucanases of the present invention and one or more amylases having an improved wash performance in cleaning or detergent applications and their use of thereof in processes such as cleaning hard surfaces and laundry. A further embodiment relates to the use of beta-glucanases of the present invention, one or more amylases and one or more further enzymes such as proteases, lipases, cutinases, cellulases, endoglucanases, xyloglucanases, pectinases, pectin lyases, xanthanases, peroxidaes, haloperoxygenases, catalases, mannanases, or any mixture thereof having an improved wash performance in cleaning or detergent applications and their use of thereof in processes such as cleaning hard surfaces and laundry. A further embodiment relates to the use of beta-glucanases of the present invention, one or more amylases, one or more proteases and one or more further enzymes such as lipases, cutinases, cellulases, endoglucanases, xyloglucanases, pectinases, pectin lyases, xanthanases, peroxidaes, haloperoxygenases, catalases, mannanases, or any mixture thereof having an improved wash performance in cleaning or detergent applications and their use of thereof in processes such as cleaning hard surfaces and laundry.

In one embodiment there is provided a cleaning or detergent composition comprising a beta-glucanase selected from the group consisting of:
(a) a polypeptide having at least 80%, at least 81%, least 82%, at least 83%, at least 84%, at least 85%, at least 86%, at least 87%, at least 88%, at least 89%, least 90%, at least 91%, least 92%, at least 93%, at least 94%, at least 95%, at least 96%, at least 97%, at least 98%, at least 99%, or 100% sequence identity to the mature polypeptide of SEQ ID NO: 2;
(b) a polypeptide encoded by a polynucleotide that hybridizes under medium stringency conditions, medium-high stringency conditions, high stringency conditions, or very high stringency conditions with the mature polypeptide coding sequence of SEQ ID NO: 1 or the full-length complement thereof;

(c) a polypeptide encoded by a polynucleotide having at least 80%, at least 81%, least 82%, at least 83%, at least 84%, at least 85%, at least 86%, at least 87%, at least 88%, at least 89%, least 90%, at least 91%, least 92%, at least 93%, at least 94%, at least 95%, at least 96%, at least 97%, at least 98%, at least 99%, or 100% sequence identity to the mature polypeptide coding sequence of SEQ ID NO: 1;

(d) a variant of the mature polypeptide of SEQ ID NO: 2 comprising a substitution, deletion, and/or insertion at one or more (e.g. several) positions; and
(e) a fragment of the polypeptide of (a), (b), (c), or (d) that has beta-glucanase activity;
   and an alpha-amylase selected from the group consisting of:
(a) a polypeptide having at least 90% sequence identity to SEQ ID NO: 3
(b) a polypeptide having at least 90% sequence identity to SEQ ID NO: 3 wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
(c) a polypeptide having at least 90% sequence identity to SEQ ID NO: 4
(d) a polypeptide having at least 90% sequence identity to the hybrid polypeptide of SEQ ID NO: 5;
(e) a polypeptide having at least 90% sequence identity to the hybrid polypeptide SEQ ID NO: 5 wherein the hybrid polypeptide comprises a substitution, a deletion or an insertion in one of more of positions: 48, 49, 107, 156, 181, 190, 197, 201, 209 and/or 264;
(f) a polypeptide having at least 90% sequence identity to SEQ ID NO: 6
(g) a polypeptide having at least 90% sequence identity to SEQ ID NO: 6 wherein the polypeptide comprises a substitution, a deletion or an insertion in one of more of positions: 181, 182, 183, 184, 195, 206, 212, 216 and/or 269;
(h) a polypeptide having at least 90% sequence identity to SEQ ID NO: 7, SEQ ID NO: 8 or SEQ ID NO: 9;
(i) a polypeptide having at least 90% sequence identity to SEQ ID NO: 7, SEQ ID NO: 8 or SEQ ID NO: 9 wherein the polypeptide comprises a substitution, a deletion or an insertion in one of more of positions: 140, 183, 184 195, 206, 243, 260, 304 and/or 476;
(j) a polypeptide having at least 90% sequence identity to SEQ ID NO: 10;
(k) a polypeptide having at least 90% sequence identity to SEQ ID NO: 11
(l) a polypeptide having at least 90% sequence identity to SEQ ID NO: 11 wherein the polypeptide comprises a substitution, a deletion or an insertion in one of more of positions: 176, 177, 178, 179, 190, 201, 207, 211 and/or 264;
(m) a polypeptide having at least 90% sequence identity to SEQ ID NO: 12
(n) a polypeptide having at least 90% sequence identity to SEQ ID NO: 12 wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475; and
(o) a polypeptide having at least 90% sequence identity to SEQ ID NO: 11 wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484.
   In a preferred embodiment, the cleaning or detergent composition may further comprise a protease selected from the group consisting of:
(a) a polypeptide having at least 90% sequence identity to SEQ ID NO: 13
(b) a polypeptide having at least 90% sequence identity to SEQ ID NO: 13 wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
(c) a polypeptide having at least 90% sequence identity to the amino acid sequence of SEQ ID NO: 14; and
(d) a polypeptide having at least 90% sequence identity to the amino acid sequence of SEQ ID NO: 14 wherein the polypeptide comprises a substitution in one or more of positions: 3, 4, 99, 101, 103, 104, 159, 194, 199, 205 and/or 217.

In one embodiment of the invention, the cleaning or detergent composition comprises a beta-glucanase corresponding to amino acids 1 to 214 of SEQ ID NO: 2 and a polypeptide having at least 90% sequence identity to SEQ ID NO: 11.

The cleaning and detergent composition of the invention shows increased enzyme detergency benefit and improved wash performance in cleaning and/or detergent applications.

In one embodiment of the invention, the cleaning or detergent composition comprises a beta-glucanase corresponding to amino acids 1 to 214 of SEQ ID NO: 2, a polypeptide having at least 90% sequence identity to SEQ ID NO: 11 and a polypeptide having at least 90% sequence identity to SEQ ID NO: 13.

The cleaning and detergent composition of the invention shows increased enzyme detergency benefit and improved wash performance in cleaning and/or detergent applications.

### Amylases

The amylase which can be used together with a beta-glucanase of the invention may be an alpha-amylase, a beta-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Amylases which can be used together with a beta-glucanase of the invention are alpha-amylases, selected from the group consisting of:
(a) a polypeptide having at least 90% sequence identity to SEQ ID NO: 3
(b) a polypeptide having at least 90% sequence identity to SEQ ID NO: 3 wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
(c) a polypeptide having at least 90% sequence identity to SEQ ID NO: 4
(d) a polypeptide having at least 90% sequence identity to the hybrid polypeptide of SEQ ID NO: 5;
(e) a polypeptide having at least 90% sequence identity to the hybrid polypeptide SEQ ID NO: 5 wherein the hybrid polypeptide comprises a substitution, a deletion or an insertion in one of more of positions: 48, 49, 107, 156, 181, 190, 197, 201, 209 and/or 264;
(f) a polypeptide having at least 90% sequence identity to SEQ ID NO: 6
(g) a polypeptide having at least 90% sequence identity to SEQ ID NO: 6 wherein the polypeptide comprises a substitution, a deletion or an insertion in one of more of positions: 181, 182, 183, 184, 195, 206, 212, 216 and/or 269;
(h) a polypeptide having at least 90% sequence identity to SEQ ID NO: 7, SEQ ID NO: 8 or SEQ ID NO: 9;
(i) a polypeptide having at least 90% sequence identity to SEQ ID NO: 7, SEQ ID NO: 8 or SEQ ID NO: 9 wherein the polypeptide comprises a substitution, a deletion or an insertion in one of more of positions: 140, 183, 184 195, 206, 243, 260, 304 and/or 476;
(j) a polypeptide having at least 90% sequence identity to SEQ ID NO: 10;
(k) a polypeptide having at least 90% sequence identity to SEQ ID NO: 11
(l) a polypeptide having at least 90% sequence identity to SEQ ID NO: 11 wherein the polypeptide comprises a substitution, a deletion or an insertion in one of more of positions: 176, 177, 178, 179, 190, 201, 207, 211 and/or 264;
(m) a polypeptide having at least 90% sequence identity to SEQ ID NO: 12
(n) a polypeptide having at least 90% sequence identity to SEQ ID NO: 12 wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475; and
(o) a polypeptide having at least 90% sequence identity to SEQ ID NO: 11 wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484.

Amylases which can be used together with a beta-glucanase of the invention are amylases having SEQ ID NO: 3 or SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444 of SEQ ID NO: 3 in WO 95/10603.

Different amylases which can be used together with a beta-glucanase of the invention are amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which can be used together with a beta-glucanase of the invention are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, 1201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 which can be used together with a beta-glucanase of the invention are those having the substitutions:

M197T;

H156Y+A181T+N190F+A209V+Q264S; or

G48+T49+G107+H156+A181+N190+I201+A209+Q264.

Further amylases which can be used together with a beta-glucanase of the invention are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, 1206, E212, E216 and K269. Particularly preferred amylases which can be used together with a beta-glucanase of the invention are those having deletion in positions G182 and H183 or positions H183 and G184.

Additional amylases which can be used together with a beta-glucanase of the invention are those having SEQ ID NO: 1, SEQ ID NO: 2 or SEQ ID NO: 7 of WO 96/023873 or variants thereof having 90% sequence identity to SEQ ID NO: 1, SEQ ID NO: 2 or SEQ ID NO: 7. Preferred variants of SEQ ID NO: 1, SEQ ID NO: 2 or SEQ ID NO: 7 are those having a substitution, a deletion or an insertion in one or more of the following positions: 140, 181, 182, 183, 184, 195, 206, 212, 243, 260, 269, 304 and 476. More preferred variants are those having a deletion in positions 182 and 183 or positions 183 and 184. Most preferred amylase variants of SEQ ID NO: 1, SEQ ID NO: 2 or SEQ ID NO: 7 which can be used together with a beta-glucanase of the invention are those having a deletion in positions 183 and 184 and a substitution in positions 140, 195, 206, 243, 260, 304 and 476.

Other amylases which can be used together with a beta-glucanase of the invention are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further amylases which can be used together with a beta-glucanase of the invention are amylases having SEQ ID NO: 2 of WO 09/061380 or variants thereof having 90% sequence identity to SEQ ID NO: 2. Preferred variants of SEQ ID NO: 2 are those having a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T1651, K178L, T182G, M201L, F202Y, N225E,R, N272E,R, S243Q,A,E,D, Y305R, R309A, Q320R, Q359E, K444E and G475K and/or deletion in position R180 and/or S181. Most preferred amylase variants of SEQ ID NO: 2 which can be used together with a beta-glucanase of the invention are those having the substitutions:

N128C+K178L+T182G+Y305R+G475K;

N128C+K178L+T182G+F202Y+Y305R+D319T+G475K;

S125A+N128C+K178L+T182G+Y305R+G475K; or

S125A+N128C+T131I+T165I+K178L+T182G+Y305R+G475K wherein the variant optionally further comprises a substitution at position 243 and/or a deletion at position 180 and/or position 181.

Other amylases which can be used together with a beta-glucanase of the invention are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases which can be used together with a beta-glucanase of the invention include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Commercially available amylases are Duramyl™, Termamyl™, Fungamyl™, Stainzyme™, Stainzyme PIus™, Natalase™ and BAN™ (Novozymes A/S), Rapidase™ and Purastar™ (from Genencor International Inc.).

### Enzyme of the Present Invention

In one embodiment, the beta-glucanase of the present invention may be added to a cleaning or detergent composition in an amount corresponding to 0.0001-200 mg of enzyme protein, such as 0.0005-100 mg of enzyme protein, preferably 0.001-30 mg of enzyme protein, more preferably 0.005-8 mg of enzyme protein, even more preferably 0.01-2 mg of enzyme protein per litre of wash liquor.

A composition for use in automatic dish wash (ADW), for example, may include 0.0001%-50%, such as 0.001%-20%, such as 0.01%-10%, such as 0.05-5% of enzyme protein by weight of the composition.

A composition for use in laundry granulation, for example, may include 0.0001%-50%, such as 0.001%-20%, such as 0.01%-10%, such as 0.05%-5% of enzyme protein by weight of the composition.

A composition for use in laundry liquid, for example, may include 0.0001%-10%, such as 0.001-7%, such as 0.1%-5% of enzyme protein by weight of the composition.

In an embodiment, the amylase may be added to the cleaning or detergent composition in an amount corresponding to 0.0001-200 mg of enzyme protein, such as 0.0005-100 mg of enzyme protein, preferably 0.001-30 mg of enzyme protein, more preferably 0.01-10 mg of enzyme protein, even more preferably 0.04-4 mg of enzyme protein per litre of wash liquor.

In an embodiment, the protease may be added to a detergent composition in an amount corresponding to 0.001-200 mg of protein, such as 0.005-100 mg of protein, preferably 0.01-50 mg of protein, more preferably 0.05-20 mg of protein, even more preferably 0.1-10 mg of protein per litre of wash liquor.

The ratio of the amount of beta-glucanase of the invention in mg enzyme protein per litre of wash liquor to the amount of amylase in mg enzyme protein per litre of wash liquor can be between 50:1 and 1:50 beta-glucanase: amylase, preferably between 10:1 and 1:20 beta-glucanase: amylase, more preferably between 5:1 and 1:10 beta-glucanase: amylase, even more preferably between 2:1 and 1:5 beta-glucanase: amylase.

The ratio of the amount of beta-glucanase of the invention in mg enzyme protein per litre of wash liquor to the amount of protease in mg enzyme protein per litre of wash liquor can be between 25:1 and 1:200 beta-glucanase: protease, preferably between 10:1 and 1:100 beta-glucanase: protease, more preferably between 2:1 and 1:40 beta-glucanase: protease, even more preferably between 1:2 and 1:20 beta-glucanase: protease.

The enzyme(s) of the cleaning or detergent composition of the invention may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in, for example, WO92/19709 and WO92/19708.

In certain markets different wash conditions and, as such, different types of detergents are used. This is disclosed in e.g. EP 1 025 240. For example, In Asia (Japan) a low detergent concentration system is used, while the United States uses a medium detergent concentration system, and Europe uses a high detergent concentration system.

A low detergent concentration system includes detergents where less than about 800 ppm of detergent components is present in the wash water. Japanese detergents are typically considered low detergent concentration system as they have approximately 667 ppm of detergent components present in the wash water.

A medium detergent concentration includes detergents where between about 800 ppm and about 2000 ppm of detergent components are present in the wash water. North American detergents are generally considered to be medium detergent concentration systems as they have approximately 975 ppm of detergent components present in the wash water.

A high detergent concentration system includes detergents where greater than about 2000 ppm of detergent components are present in the wash water. European detergents are generally considered to be high detergent concentration systems as they have approximately 4500-5000 ppm of detergent components in the wash water.

Latin American detergents are generally high suds phosphate builder detergents and the range of detergents used in Latin America can fall in both the medium and high detergent concentrations as they range from 1500 ppm to 6000 ppm of detergent components in the wash water. Such detergent compositions are all embodiments of the invention.

A polypeptide of the present invention may also be incorporated in the detergent formulations disclosed in WO 97/07202, which is hereby incorporated by reference.

### Surfactants

The cleaning or detergent composition may comprise one or more surfactants, which may be anionic and/or cationic and/or non-ionic and/or semi-polar and/or zwitterionic, or a mixture thereof. In a particular embodiment, the cleaning or detergent composition includes a mixture of one or more nonionic surfactants and one or more anionic surfactants. The surfactant(s) is typically present at a level of from about 0.1% to 60% by weight, such as about 1% to about 40%, or about 3% to about 20%, or about 3% to about 10%. The surfactant(s) is chosen based on the desired cleaning application, and includes any conventional surfactant(s) known in the art. Any surfactant known in the art for use in detergents may be utilized.

When included therein the detergent will usually contain from about 1% to about 40% by weight, such as from about 5% to about 30%, including from about 5% to about 15%, or from about 20% to about 25% of an anionic surfactant. Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or soap, and combinations thereof.

When included therein the detergent will usually contain from about 0% to about 10% by weight of a cationic surfactant. Non-limiting examples of cationic surfactants include alklydimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, and combinations thereof.

When included therein the detergent will usually contain from about 0.2% to about 40% by weight of a non-ionic surfactant, for example from about 0.5% to about 30%, in particular from about 1% to about 20%, from about 3% to about 10%, such as from about 3% to about 5%, or from about 8% to about 12%. Non-limiting examples of non-ionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxy alkyl fatty acid amides, or N-acyl N-alkyl derivatives of glucosamine (glucamides, GA, or fatty acid glucamide, FAGA), as well as products available under the trade names SPAN and TWEEN, and combinations thereof.

When included therein the detergent will usually contain from about 0% to about 10% by weight of a semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, fatty acid alkanolamides and ethoxylated fatty acid alkanolamides, and combinations thereof.

When included therein the detergent will usually contain from about 0% to about 10% by weight of a zwitterionic surfactant. Non-limiting examples of zwitterionic surfactants include betaine, alkyldimethylbetaine, sulfobetaine, and combinations thereof.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in cleaning or detergent compositions allow for example more concentrated formulations of surfactants (as in the process of compacting liquid detergents by removing water) without inducing undesired phenomena such as phase separation or high viscosity.

The detergent may contain 0-5% by weight, such as about 0.5 to about 5%, or about 3% to about 5%, of a hydrotrope. Any hydrotrope known in the art for use in detergents may be utilized. Non-limiting examples of hydrotropes include sodium benzene sulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The cleaning or detergent composition may contain about 0-65% by weight, such as about 5% to about 45% of a detergent builder or co-builder, or a mixture thereof. In a dish wash detergent, the level of builder is typically 40-65%, particularly 50-65%. The builder and/or co-builder may particularly be a chelating agent that forms water-soluble complexes with Ca and Mg. Any builder and/or co-builder known in the art for use in laundry detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as iminodiethanol), triethanolamine (TEA, also known as 2,2′,2″-nitrilotriethanol), and carboxymethyl inulin (CMI), and combinations thereof.

The cleaning or detergent composition may also contain 0-20% by weight, such as about 5% to about 10%, of a detergent co-builder, or a mixture thereof. The cleaning or detergent composition may include include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra-(methylenephosphonic acid) (EDTMPA), diethylenetriaminepentakis(methylenephosphonic acid) (DTPMPA or DTMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N, N-diacetic acid (α-ALDA), serine-N, N-diacetic acid (SEDA), isoserine-N, N-diacetic acid (ISDA), phenylalanine-N, N-diacetic acid (PHDA), anthranilic acid-N, N-diacetic acid (ANDA), sulfanilic acid-N, N-diacetic acid (SLDA), taurine-N, N-diacetic acid (TUDA) and sulfomethyl-N, N-diacetic acid (SMDA), N-(2-hydroxyethyl)ethylidenediamine-N,N,N′-triacetate (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

### Bleaching Systems

The detergent may contain 0-50% by weight, such as about 0.1% to about 25%, of a bleaching system. Any bleaching system known in the art for use in laundry detergents may be utilized. Suitable bleaching system components include bleaching catalysts, photobleaches, bleach activators, sources of hydrogen peroxide such as sodium percarbonate and sodium perborates, preformed peracids and mixtures thereof. Suitable preformed peracids include, but are not limited to, peroxycarboxylic acids and salts, percarbonic acids and salts, perimidic acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. The term bleach activator is meant herein as a compound which reacts with peroxygen bleach like hydrogen peroxide to form a peracid. The peracid thus formed constitutes the activated bleach. Suitable bleach activators to be used herein include those belonging to the class of esters amides, imides or anhydrides. Suitable examples are tetracetylethylene diamine (TAED), sodium 4-[(3,5,5-trimethylhexanoyl)oxy]benzene sulfonate (ISONOBS), diperoxy dodecanoic acid, 4-(dodecanoyloxy)benzenesulfonate (LOBS), 4-(decanoyloxy)benzenesulfonate, 4-(decanoyloxy)benzoate (DOBS), 4-(nonanoyloxy)-benzenesulfonate (NOBS), and/or those disclosed in WO98/17767. A particular family of bleach activators of interest was disclosed in EP624154 and particulary preferred in that family is acetyl triethyl citrate (ATC). ATC or a short chain triglyceride like triacetin has the advantage that it is environmental friendly as it eventually degrades into citric acid and alcohol. Furthermore acetyl triethyl citrate and triacetin has a good hydrolytical stability in the product upon storage and it is an efficient bleach activator. Finally ATC provides a good building capacity to the laundry additive. Alternatively, the bleaching system may comprise peroxyacids of, for example, the amide, imide, or sulfone type. The bleaching system may also comprise peracids such as 6-(phthalimido)peroxyhexanoic acid (PAP). The bleaching system may also include a bleach catalyst. In some embodiments the bleach component may be an organic catalyst selected from the group consisting of organic catalysts having the following formulae:

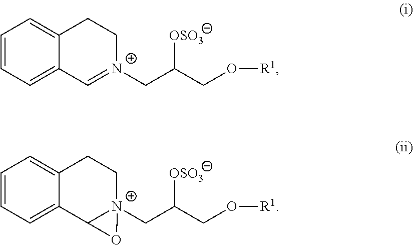

(iii) and mixtures thereof; wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl. Other exemplary bleaching systems are described, e.g. in WO 2007/087258, WO 2007/087244, WO 2007/087259 and WO 2007/087242. Suitable photobleaches may for example be sulfonated zinc phthalocyanine

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

### Fabric Hueing Agents

The cleaning or detergent compositions of the present invention may also include fabric hueing agents such as dyes or pigments, which when formulated in cleaning or detergent compositions can deposit onto a fabric when said fabric is contacted with a wash liquor comprising said cleaning or detergent compositions and thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO 2005/03274, WO 2005/03275, WO 2005/03276 and EP 1876226 (hereby incorporated by reference). The cleaning or detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO 2007/087243.

Proteases

The protease may be of animal, vegetable or microbial origin, including chemically or genetically modified mutants. Microbial origin is preferred. It may be an alkaline protease, such as a serine protease or a metalloprotease. A serine protease may for example be of the S1 family, such as trypsin, or the S8 family such as subtilisin. A metalloproteases protease may for example be a lysin from e.g. family M4, M5, M7 or M8.

In one embodiment the protease is selected from the group consisting of:
(a) a polypeptide having at least 90% sequence identity to SEQ ID NO: 13
(b) a polypeptide having at least 90% sequence identity to SEQ ID NO: 13 wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
(c) a polypeptide having at least 90% sequence identity to the amino acid sequence of SEQ ID NO: 14; and
(d) a polypeptide having at least 90% sequence identity to the amino acid sequence of SEQ ID NO: 14 wherein the polypeptide comprises a substitution in one or more of positions: 3, 4, 99, 101, 103, 104, 159, 194, 199, 205 and/or 217.

The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterised by having a serine in the active site, which forms a covalent adduct with the substrate. Further the subtilases (and the serine proteases) are characterised by having two active site amino acid residues apart from the serine, namely a histidine and an aspartic acid residue.

Examples of subtilisins are those derived from Bacillus such as subtilisin lentus, Bacillus lentus, subtilisin Novo, subtilisin Carlsberg, Bacillus licheniformis, subtilisin BPN′, subtilisin 309, subtilisin 147 and subtilisin 168 described in WO 89/06279 and protease PD138 (WO 93/18140). Additional serine protease examples are described in WO 98/020115, WO 01/44452, WO 01/58275, WO 01/58276, WO 03/006602 and WO 04/099401. Preferred subtilisin variants of SEQ ID NO: 4 of WO 03/006602 have mutations in positions 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and 274 using BPN′ numbering. More preferred subtilisin variants of SEQ ID NO: 4 of WO 03/006602, using BPN′ numbering, are those having the mutations:

S9+A15+V68+H120+N218+Q245;

S9+A15+V68+A98+S99+N218+Q245;

S9+A15+V68+N218+Q245;

K27+V104+N123+T274;

*36D+N76+H120+G195+K235;

V68+S106;

N76+S87+G118+S128+P129+S130,

N76+S103+V104;

S87N;

S87+S101+V104;

S87+M222;

587+G118+S128+P129+S130,

S87+S101+G118+S128+P129+S130;

*97E;

S99AD;

S101+S103+V104+G160+A232+Q236+Q245+N248+N252;

Y167+R170+A194; or
M222S.

The amino acid sequence of BLAP is shown in FIG. 29 of U.S. Pat. No. 5,352,604 with the following mutations S99D+S101R+S103A+V104I+G159S. BLAP X is BLAP with the mutations S3T+V4I+V2051, BLAP R is BLAP with the mutations S3T+V4I+V199M+V205I+L217D and BLAP S is BLAP with the mutations S3T+V4I+A194P+V199M+V205I+L217D.

Examples of trypsin-like proteases are trypsin (e.g. of porcine or bovine origin) and the Fusarium protease described in WO 89/06270 and WO 94/25583. Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235, and 274.

Examples of metalloproteases are the neutral metalloprotease as described in WO 07/044993.

Preferred commercially available protease enzymes include Alcalase™, Coronase, Duralase™, Durazym™, Esperase™, Everlase™, Kannase™, Liquanase™, Liquanase Ultra™ Ovozyme™, Polarzyme™, Primase™, Relase™, Savinase™ and Savinase Ultra™, (Novozymes NS), Axapem™ (Gist-Brocases N.V.), BLAP and BLAP X (Henkel AG & Co. KGaA), Excellase™ FN2™, FN3™, FN4™, Maxacal™, Maxapem™, Maxatase™, Properase™, Purafast™, Purafect™ Purafect OxP™, Purafect™ Prime and Puramax™ (Danisco US Inc, formerly Genencor International Inc.).

### Additional Enzymes

The detergent additive as well as the cleaning or detergent composition may comprise one or more [additional]enzymes such as a protease, lipase, cutinase, an amylase, carbohydrase, cellulase, pectinase, mannanase, arabinase, galactanase, xylanase, oxidase, e.g., a laccase, and/or peroxidase.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

Cellulases: Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and PCT/DK98/00299.

Commercially available cellulases include Celluzyme™, Celluclean™, Celluclean L™, and Carezyme™ (Novozymes NS), Clazinase™, and Puradax HA™ (Genencor International Inc.), and KAC-500(B)™ (Kao Corporation).

Lipases and Cutinases: Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP 258068 and EP 305216, cutinase from Humicola, e.g. H. insolens (WO96/13580), lipase from strains of Pseudomonas (some of these now renamed to Burkholderia), e.g. P. alcaligenes or P. pseudoalcaligenes (EP 218272), P. cepacia (EP 331376), P. sp. strain SD705 (WO 95/06720 & WO 96/27002), P. wisconsinensis (WO 96/12012), GDSL-type Streptomyces lipases (WO 10/065455), cutinase from Magnaporthe grisea (WO 10/107560), cutinase from Pseudomonas mendocina (U.S. Pat. No. 5,389,536), lipase from Thermobifida Fusca (WO 11/084412), Geobacillus stearothermophilus lipase (WO 11/084417), lipase from Bacillus subtilis (WO 11/084599), and lipase from Streptomyces griseus (WO 11/150157) and S. pristinaespiralis (WO 12/137147).

Other examples are lipase variants such as those described in EP 407225, WO 92/05249, WO 94/01541, WO 94/25578, WO 95/14783, WO 95/30744, WO 95/35381, WO 95/22615, WO 96/00292, WO 97/04079, WO 97/07202, WO 00/34450, WO 00/60063, WO 01/92502, WO 07/87508 and WO 09/109500.

Preferred commercial lipase products include include Lipolase™, Lipex™; Lipolex™ and Lipoclean™ (Novozymes NS), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO 10/111143), acyltransferase from Mycobacterium smegmatis (WO 05/56782), perhydrolases from the CE 7 family (WO 09/67279), and variants of the M. smegmatis perhydrolase in particular the 554V variant used in the commercial product Gentle Power Bleach from Huntsman Textile Effects Pte Ltd (WO 10/100028).

Peroxidases/Oxidases: Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257. Commercially available peroxidases include Guardzyme™ (Novozymes NS).

The detergent enzyme(s) may be included in a cleaning or detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries.

Non-dusting granulates may be produced, e.g., as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

### Adjunct Materials

Any detergent components known in the art for use in laundry detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry detergents may be utilized. The choice of such ingredients is well within the skill of the artisan.

Dispersants: The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

Dye Transfer Inhibiting Agents: The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Fluorescent whitening agent: The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino) stilbene-2,2′-disulfonate, 4,4′-bis-(2,4-dianilino-s-triazin-6-ylamino) stilbene-2,2′-disulfonate, 4,4′-bis-(2-anilino-4-(N-methyl-N-2-hydroxy-ethylamino)-s-triazin-6-ylamino) stilbene-2,2′-disulfonate, 4,4′-bis-(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino) stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

Soil release polymers: The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose derivatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

Anti-redeposition agents: The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Formulation of Cleaning or Detergent Products

The cleaning or detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid. There are a number of detergent formulation forms such as layers (same or different phases), pouches, as well as forms for machine dosing unit.

Pouches can be configured as single or multicompartments. It can be of any form, shape and material which is suitable for hold the composition, e.g. without allowing the release of the composition from the pouch prior to water contact. The pouch is made from water soluble film which encloses an inner volume. Said inner volume can be devided into compartments of the pouch. Preferred films are polymeric materials preferably polymers which are formed into a film or sheet. Preferred polymers, copolymers or derivates therof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxyprpyl methyl cellulose (HPMC). Preferably the level of polymer in the film for example PVA is at least about 60%. Preferred average molecular weight will typically be about 20,000 to about 150,000. Films can also be of blend compositions comprising hydrolytically degradable and water soluble polymer blends such as polyactide and polyvinyl alcohol (known under the Trade reference M8630 as sold by Chris Craft In. Prod. Of Gary, Ind., US) plus plasticisers like glycerol, ethylene glycerol, Propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids. Ref: (US 2009/0011970 A1).

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may be non-aqueous.

### Laundry Soap Bars

The enzymes of the invention may be added to laundry soap bars and used for hand washing laundry, fabrics and/or textiles. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na⁺, K⁺ or NH₄⁺ and the organic anion may be for example formate, acetate, citrate or lactate such that the salt of a monovalent cation and an organic anion may be, for example, sodium formate.

The laundry soap bar may also contain complexing agents like EDTA and HEDP, perfumes and/or different type of fillers, surfactants e.g. anionic synthetic surfactants, builders, polymeric soil release agents, detergent chelators, stabilizing agents, fillers, dyes, colorants, dye transfer inhibitors, alkoxylated polycarbonates, suds suppressers, structurants, binders, leaching agents, bleaching activators, clay soil removal agents, anti-redeposition agents, polymeric dispersing agents, brighteners, fabric softeners, perfumes and/or other compounds known in the art.

The laundry soap bar may be processed in conventional laundry soap bar making equipment such as but not limited to: mixers, plodders, e.g a two stage vacuum plodder, extruders, cutters, logo-stampers, cooling tunnels and wrappers. The invention is not limited to preparing the laundry soap bars by any single method. The premix of the invention may be added to the soap at different stages of the process. For example, the premix containing a soap, an enzyme, optionally one or more additional enzymes, a protease inhibitor, and a salt of a monovalent cation and an organic anion may be prepared and and the mixture is then plodded. The enzyme and optional additional enzymes may be added at the same time as the protease inhibitor for example in liquid form. Besides the mixing step and the plodding step, the process may further comprise the steps of milling, extruding, cutting, stamping, cooling and/or wrapping.

### Granular Detergent Formulations

A granular detergent may be formulated as described in WO 09/092699, EP 1705241, EP 1382668, WO 07/001262, U.S. Pat. No. 6,472,364, U.S. Pat. No. 6,472,364 or WO 09/102854. Other useful detergent formulations are described in WO 09/124162, WO 09/124163, WO 09/117340, WO 09/117341, WO 09/117342, WO 09/072069, WO 09/063355, WO 09/132870, WO 09/121757, WO 09/112296, WO 09/112298, WO 09/103822, WO 09/087033, WO 09/050026, WO 09/047125, WO 09/047126, WO 09/047127, WO 09/047128, WO 09/021784, WO 09/010375, WO 09/000605, WO 09/122125, WO 09/095645, WO 09/040544, WO 09/040545, WO 09/024780, WO 09/004295, WO 09/004294, WO 09/121725, WO 09/115391, WO 09/115392, WO 09/074398, WO 09/074403, WO 09/068501, WO 09/065770, WO 09/021813, WO 09/030632 and WO 09/015951.

WO 2011025615, WO 2011016958, WO 2011005803, WO 2011005623, WO 2011005730, WO 2011005844, WO 2011005904, WO 2011005630, WO 2011005830, WO 2011005912, WO 2011005905, WO 2011005910, WO 2011005813, WO 2010135238, WO 2010120863, WO 2010108002, WO 2010111365, WO 2010108000, WO 2010107635, WO 2010090915, WO 2010033976, WO 2010033746, WO 2010033747, WO 2010033897, WO 2010033979, WO 2010030540, WO 2010030541, WO 2010030539, WO 2010024467, WO 2010024469, WO 2010024470, WO 2010025161, WO 2010014395, WO 2010044905,

WO 2010145887, WO 2010142503, WO 2010122051, WO 2010102861, WO 2010099997, WO 2010084039, WO 2010076292, WO 2010069742, WO 2010069718, WO 2010069957, WO 2010057784, WO 2010054986, WO 2010018043, WO 2010003783, WO 2010003792,

WO 2011023716, WO 2010142539, WO 2010118959, WO 2010115813, WO 2010105942, WO 2010105961, WO 2010105962, WO 2010094356, WO 2010084203, WO 2010078979, WO 2010072456, WO 2010069905, WO 2010076165, WO 2010072603, WO 2010066486, WO 2010066631, WO 2010066632, WO 2010063689, WO 2010060821, WO 2010049187, WO 2010031607, WO 2010000636,

### Method of Producing the Composition

The present invention also relates to methods of producing the composition. The method may be relevant for the (storage) stability of the cleaning or detergent composition: e.g. soap bar premix method WO2009155557.

### Uses

The soils and stains that are important for cleaning are composed of many different substances, and a range of different enzymes, all with different substrate specificities, have been developed for use in detergents both in relation to laundry and hard surface cleaning, such as dishwashing. These enzymes are considered to provide an enzyme detergency benefit, since they specifically improve stain removal in the cleaning process they are applied in as compared to the same process without enzymes. Stain removing enzymes that are known in the art include enzymes such as proteases, lipases, cutinases, cellulases, endoglucanases, xyloglucanases, pectinases, pectin lyases, xanthanases, peroxidaes, haloperoxygenases, catalases and mannanases.

In one aspect, the invention concerns the use of beta-glucanase of the present invention together with one or more amylases in cleaning or detergent compositions, for use in cleaning hard-surfaces, such as dish wash, or in laundering or for stain removal. In an additional aspect, the present invention demonstrates that the beta-glucanases of the invention together with one or more amylases have an enzyme detergency benefit and/or improved wash performance in cleaning or detergent applications, such as dish wash or laundering, on various stains and under various conditions. In a further aspect, the present invention demonstrates that the beta-glucanases of the invention together with one or more amylases have an enzyme detergency benefit and/or improved wash performance in cleaning or detergent applications on oat stains, such as chocolate/porridge oat stains or cocoa/oat flake stains. In another aspect of the invention, the cleaning or detergent composition comprises of a beta-glucanase of the present invention together with one or more amylases and one or more of the above mentioned stain removal enzymes, such as another protease, have an enzyme detergency benefit in cleaning or detergent applications, such as dish wash and laundering, on various stains, such as chocolate/porridge oat stains or cocoa/oat flake stains.

In another aspect, the invention relates to a laundering process which can be for household laundering as well as industrial laundering. Furthermore, the invention relates to a process for the laundering of textiles (e.g. fabrics, garments, cloths etc.) where the process comprises treating the textile with a washing solution containing a cleaning or detergent composition and at least one beta-glucanase of the present invention together with one or more amylases. The laundering can for example be carried out using a household or an industrial washing machine or be carried out by hand using a cleaning or detergent composition containing a beta-glucanase of the invention together with one or more amylases.

In another aspect, the invention relates to a dish wash process which can be for household dish wash as well as industrial dish wash. Furthermore, the invention relates to a process for the washing of hard surfaces (e.g. cutlery such as knives, forks, spoons; crockery such as plates, glasses, bowls, pans) where the process comprises treating the hard surface with a washing solution containing a cleaning or detergent composition and at least one beta-glucanase of the present invention together with one or more amylases. The hard surface washing can for example be carried out using a household or an industrial dishwasher or be carried out by hand using a cleaning or detergent composition containing a beta-glucanase of the invention together with one or more amylases, optionally one or more protease and optionally one or more further enzymes selected from the group comprising of lipases, cutinases, cellulases, endoglucanases, xyloglucanases, pectinases, pectin lyases, xanthanases, peroxidaes, haloperoxygenases, catalases, mannanases, or any mixture thereof.

The cleaning or detergent composition of the present invention may be formulated, for example, as a hand or machine laundry detergent composition including a laundry additive composition suitable for pre-treatment of stained fabrics and a rinse added fabric softener composition, or be formulated for hand or machine dishwashing operations. In a specific aspect, the present invention provides a detergent additive comprising a beta-glucanase of the present invention together with one or more amylases as described herein. In a further aspect, the detergent additive comprises a beta-glucanase of the present invention together with one or more amylases, optionally one or more proteases and optionally one or more further enzymes selected from the group comprising of lipases, cutinases, cellulases, endoglucanases, xyloglucanases, pectinases, pectin lyases, xanthanases, peroxidaes, haloperoxygenases, catalases, mannanases, or any mixture thereof.

The invention is further summarised in the following paragraphs:
1. A cleaning or detergent composition comprising a beta-glucanase selected from the group consisting of:
   (a) a polypeptide having at least 80%, at least 81%, least 82%, at least 83%, at least 84%, at least 85%, at least 86%, at least 87%, at least 88%, at least 89%, least 90%, at least 91%, least 92%, at least 93%, at least 94%, at least 95%, at least 96%, at least 97%, at least 98%, at least 99%, or 100% sequence identity to the mature polypeptide of SEQ ID NO: 2;
   (b) a polypeptide encoded by a polynucleotide that hybridizes under medium stringency conditions, medium-high stringency conditions, high stringency conditions, or very high stringency conditions with the mature polypeptide coding sequence of SEQ ID NO: 1 or the full-length complement thereof;
   (c) a polypeptide encoded by a polynucleotide having at least 80%, at least 81%, least 82%, at least 83%, at least 84%, at least 85%, at least 86%, at least 87%, at least 88%, at least 89%, least 90%, at least 91%, least 92%, at least 93%, at least 94%, at least 95%, at least 96%, at least 97%, at least 98%, at least 99%, or 100% sequence identity to the mature polypeptide coding sequence of SEQ ID NO: 1;
   (d) a variant of the mature polypeptide of SEQ ID NO: 2 comprising a substitution, deletion, and/or insertion at one or more (e.g. several) positions; and
   (e) a fragment of the polypeptide of (a), (b), (c), or (d) that has beta-glucanase activity; and one or more amylases.
2. The cleaning or detergent composition of paragraph 1, wherein the beta-glucanase corresponds to amino acids 1 to 214 of SEQ ID NO: 2.
3. The cleaning or detergent composition of paragraph 1, comprising or consisting of SEQ ID NO: 2.
4. The cleaning or detergent composition of paragraph 1, wherein the beta-glucanase is a variant of the mature polypeptide of SEQ ID NO: 2 comprising a substitution, deletion, and/or insertion at one or more (e.g. several) positions.
5. The cleaning or detergent composition of any of paragraphs 1 to 4, wherein the amylase is an alpha-amylase.
6. The cleaning or detergent composition of paragraph 5 wherein the alpha-amylase is selected from the group consisting of:
   (a) a polypeptide having at least 90% sequence identity to SEQ ID NO: 3 of WO 95/10603;
   (b) a polypeptide having at least 90% sequence identity to SEQ ID NO: 3 in WO 95/10603 wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
   (c) a polypeptide having at least 90% sequence identity to SEQ ID NO: 6 in WO 02/010355;
   (d) a polypeptide having at least 90% sequence identity to the hybrid polypeptide comprising residues 1-33 of SEQ ID NO: 6 of WO 2006/066594 and residues 36-483 of SEQ ID NO: 4 of WO 2006/066594;
   (e) a polypeptide having at least 90% sequence identity to the hybrid polypeptide comprising residues 1-33 of SEQ ID NO: 6 of WO 2006/066594 and residues 36-483 of SEQ ID NO: 4 of WO 2006/066594 wherein the hybrid polypeptide comprises a substitution, a deletion or an insertion in one of more of positions: 48, 49, 107, 156, 181, 190, 197, 201, 209 and/or 264;
   (f) a polypeptide having at least 90% sequence identity to SEQ ID NO: 6 of WO 02/019467;
   (g) a polypeptide having at least 90% sequence identity to SEQ ID NO: 6 of WO 02/019467 wherein the polypeptide comprises a substitution, a deletion or an insertion in one of more of positions: 181, 182, 183, 184, 195, 206, 212, 216 and/or 269;
   (h) a polypeptide having at least 90% sequence identity to SEQ ID NO: 1, SEQ ID NO: 2 or SEQ ID NO: 7 of WO 96/023873
   (i) a polypeptide having at least 90% sequence identity to SEQ ID NO: 1, SEQ ID NO: 2 or SEQ ID NO: 7 of WO 96/023873 wherein the polypeptide comprises a substitution, a deletion or an insertion in one of more of positions: 140, 183, 184 195, 206, 243, 260, 304 and/or 476;
   (j) a polypeptide having at least 90% sequence identity to SEQ ID NO: 2 of WO 08/153815;
   (k) a polypeptide having at least 90% sequence identity to SEQ ID NO: 10 of WO 01/66712;
   (l) a polypeptide having at least 90% sequence identity to SEQ ID NO: 10 of WO 01/66712 wherein the polypeptide comprises a substitution, a deletion or an insertion in one of more of positions: 176, 177, 178, 179, 190, 201, 207, 211 and/or 264;
   (m) a polypeptide having at least 90% sequence identity to SEQ ID NO: 2 of WO 09/061380;
   (n) a polypeptide having at least 90% sequence identity to SEQ ID NO: 2 of WO 09/061380 wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475;
   (o) a polypeptide having at least 90% sequence identity to SEQ ID NO: 12 of WO 01/66712; and
   (p) a polypeptide having at least 90% sequence identity to SEQ ID NO: 12 of WO 01/66712 wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484.
7. The cleaning or detergent composition of any of paragraphs 1 to 6, wherein the composition comprises one or more further enzymes selected from the group comprising of proteases, lipases, cutinases, cellulases, endoglucanases, xyloglucanases, pectinases, pectin lyases, xanthanases, peroxidaes, haloperoxygenases, catalases, mannanases, or any mixture thereof.
8. The cleaning or detergent composition of any of paragraphs 1 to 6, wherein the composition comprises one or more proteases and optionally one or more further enzymes selected from the group comprising of lipases, cutinases, cellulases, endoglucanases, xyloglucanases, pectinases, pectin lyases, xanthanases, peroxidaes, haloperoxygenases, catalases, mannanases, or any mixture thereof.
9. The cleaning or detergent composition of any of paragraphs 7 to 8, wherein the protease is a serine protease of the S1 or S8 family or a metalloprotease of the M4, M5, M7 or M8 family.
10. The cleaning or detergent composition of paragraph 9 wherein the protease is selected from the group consisting of:
   (a) a polypeptide having at least 90% sequence identity to SEQ ID NO: 4 of WO 03/006602;
   (b) a polypeptide having at least 90% sequence identity to SEQ ID NO: 4 of WO 03/006602 wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
   (c) a polypeptide having at least 90% sequence identity to the amino acid sequence shown in FIG. 29 of U.S. Pat. No. 5,352,604; and
   (d) a polypeptide having at least 90% sequence identity to the amino acid sequence shown in FIG. 29 of U.S. Pat. No. 5,352,604 wherein the polypeptide comprises a substitution in one or more of positions: 3, 4, 99, 101, 103, 104, 159, 194, 199, 205 and/or 217.
11. The cleaning or detergent composition of any of paragraphs 1 to 10 for dish wash or laundering.
12. The cleaning or detergent composition of any of paragraphs 1 to 11 comprising of one or more components selected from the group comprising of surfactants, builders, hydrotopes, bleaching systems, polymers, fabric hueing agents, adjunct materials, dispersants, dye transfer inhibiting agents, fluorescent whitening agents, soil release polymers and anti-redeposition agents.
13. The cleaning or detergent composition of any of paragraphs 1 to 12 in which the composition is in form of a bar, a homogenous tablet, a tablet having two or more layers, a pouch having one or more compartments, a regular or compact powder, a granule, a paste, a gel, or a regular, compact or concentrated liquid.
14. The cleaning or detergent composition of any of paragraphs 1 to 13 having an enzyme detergency benefit in cleaning or detergent applications.
15. The cleaning or detergent composition of any of paragraphs 1 to 13 having an improved wash performance in cleaning or detergent applications.
16. A method for removing a stain from a surface which comprises contacting the surface with a composition according to any of paragraphs 1 to 13.
17. The use of a beta-glucanase selected from the group consisting of:
   (a) a polypeptide having at least 80%, at least 81%, least 82%, at least 83%, at least 84%, at least 85%, at least 86%, at least 87%, at least 88%, at least 89%, least 90%, at least 91%, least 92%, at least 93%, at least 94%, at least 95%, at least 96%, at least 97%, at least 98%, at least 99%, or 100% sequence identity to the mature polypeptide of SEQ ID NO: 2.
   (b) a polypeptide encoded by a polynucleotide that hybridizes under medium stringency conditions, medium-high stringency conditions, high stringency conditions, or very high stringency conditions with the mature polypeptide coding sequence of SEQ ID NO: 1 or the full-length complement thereof;
   (c) a polypeptide encoded by a polynucleotide having at least 80%, at least 81%, least 82%, at least 83%, at least 84%, at least 85%, at least 86%, at least 87%, at least 88%, at least 89%, least 90%, at least 91%, least 92%, at least 93%, at least 94%, at least 95%, at least 96%, at least 97%, at least 98%, at least 99%, or 100% sequence identity to the mature polypeptide coding sequence of SEQ ID NO: 1;
   (d) a variant of the mature polypeptide of SEQ ID NO: 2 comprising a substitution, deletion, and/or insertion at one or more (e.g. several) positions; and
   (e) a fragment of the polypeptide of (a), (b), (c), or (d) that has beta-glucanase activity; one or more amylases and optionally one or more further enzymes selected from the group comprising of lipases, cutinases, cellulases, endoglucanases, xyloglucanases, pectinases, pectin lyases, xanthanases, peroxidaes, haloperoxygenases, catalases, mannanases, or any mixture thereof, for dish wash or laundering.
18. The use of a composition of any of paragraphs 1 to 15 in a cleaning process, such as dish wash or laundering.
19. The cleaning or detergent composition of any of paragraphs 1 to 13 having improved stability.

The present invention is further described by the following examples that should not be construed as limiting the scope of the invention.

### EXAMPLES

TABLE 1
Composition of Liquid Model Detergent A

| Detergent ingredients | Wt % |
|---|---|
| Linear alkylbenzenesulfonic acid (LAS) (Marlon AS3) | 13 |
| Sodium alkyl(C12)ether sulfate (AEOS) (STEOL CS-370 E) | 10 |
| Coco soap (Radiacid 631) | 2.75 |
| Soy soap (Edenor SJ) | 2.75 |
| Alcohol ethoxylate (AEO) (Bio-Soft N25-7) | 11 |
| Sodium hydroxide | 2 |
| Ethanol | 3 |
| Propane-1,2-diol (MPG) | 6 |
| Glycerol | 2 |
| Triethanolamine (TEA) | 3 |
| Sodium formate | 1 |
| Sodium citrate | 2 |
| Diethylenetriaminepentakis(methylenephosphonic acid) | 0.2 |
| (DTMPA) | |
| Polycarboxylate polymer (PCA) (Sokalan CP-5) | 0.2 |
| Water | Up to 100 |

Final adjustment of pH to pH 8 with NaOH or citric acid

### Wash Assays

### Swatches

Test materials were obtained from the following companies: 035KC Chocolate porridge oats (Warwick Equest Ltd, Unit 55, Consett Business Park, Consett, County Durham, DH8 6BN UK); C-H097 Cocao/oat flakes (Center For Testmaterials BV, P.O. Box 120, 3133 KT Vlaardingen, The Netherlands).

### Terg-O-tometer (TOM)

Wash performance was measured at laboratory scale using a method similar to ASTM D3050 (ASTM International, West Conshohocken, Pa.) with the modifications mentioned here. Soiled test swatches (035KC Chocolate porridge oats and C-H097 Cocao/oat flakes) were washed in a Terg-O-tometer using 1 L detergent solution containing 3.3 g/L liquid model detergent A at 120 rpm. If enzymes were added they were dosed individually at 0.05 mg enzyme protein/L detergent solution. The swatches were washed at either 20° C. or 40° C. using artificial water hardness with 15° dH Ca++/Mg++/HCO3- (ratio 4:1:7.5) for 30 minutes then rinsed under running tap water for 5 minutes. After drying, the cleanliness of the swatches was determined by light remission using a colorimeter measurement of 460 nm.

### Evaluation of Stains for TOM

Wash performance is expressed as a remission value (REM). After washing and rinsing the swatches were spread out flat between adsorbent paper and allowed to air dry at room temperature in a dark cupboard overnight. All washes were evaluated on day 1 after the wash. Light reflectance evaluations of the washed swatches were done using a Macbeth Colour Eye 7000 reflectance spectrophotometer with very small aperture. The measurements were made without UV in the incident light and remission at 460 nm was extracted. The test swatch to be measured was placed on top of another swatch of same type and colour (twin swatch from the same wash condition). The wash performance for each swatch was calculated as the average of the individual remission values.

### Enzyme Assays

### Beta-Glucanase Activity (AZCL-Beta-Glucan Assay)

Substrate: AZCL-beta-glucan (dyed beta-glucan; I-AZBGL from Megazyme)
Temperature: 37° C.
Assay buffer: 100 mM succinic acid, 100 mM HEPES, 100 mM CHES, 100 mM CABS, 1 mM CaCl₂, 150 mM KCl, 0.01% Triton X-100, pH 8.0.

A 4 mg/ml AZCL-beta-glucan suspension was prepared by mixing AZCL-beta-glucan in 0.01% Triton X-100 by gentle stirring. 5004 of this suspension and 5004 assay buffer were dispensed in an Eppendorf tube and placed on ice. 204 enzyme sample (diluted in 0.01% Triton X-100) was added. The assay was initiated by transferring the Eppendorf tube to an Eppendorf thermomixer, which was set to the assay temperature. The tube was incubated for 15 minutes on the Eppendorf thermomixer at its highest shaking rate (1400 rpm.). The incubation was stopped by transferring the tube back to the ice bath. Then the tube was centrifuged in an ice cold centrifuge for a few minutes and 2004 supernatant was transferred to a microtiter plate. OD₆₅₀ was read as a measure of beta-glucanase activity. A buffer blind was included in the assay (instead of enzyme).

### Protease Activity (Suc-AAPF-pNA Assay)

pNA substrate: Suc-AAPF-pNA (Bachem L-1400).
Temperature: Room temperature (25° C.)
Assay buffers: 100 mM succinic acid, 100 mM HEPES, 100 mM CHES, 100 mM CABS, 1 mM CaCl₂, 150 mM KCl, 0.01% Triton X-100, pH 8.0.

20 μL enzyme sample was mixed with 1004 assay buffer. The assay was started by adding 100 μl pNA substrate (50 mg dissolved in 1.0 ml DMSO and further diluted 45× with 0.01% Triton X-100). The increase in OD₄₀₅ was monitored as a measure of the protease activity.

### Alpha-Amylase Activity (AZCL-Amylose Assay)

Substrate: AZCL-amylose (dyed amylose; I-AZAMY from Megazyme)
Temperature: 37° C.
Assay buffer: 100 mM succinic acid, 100 mM HEPES, 100 mM CHES, 100 mM CABS, 1 mM CaCl₂, 150 mM KCl, 0.01% Triton X-100, pH 8.0.

A 4 mg/ml AZCL-amylose suspension was prepared by mixing AZCL-amylose in 0.01% Triton X-100 by gentle stirring. 5004 of this suspension and 5004 assay buffer were dispensed in an Eppendorf tube and placed on ice. 204 enzyme sample was added. The assay was initiated by transferring the Eppendorf tube to an Eppendorf thermomixer, which was set to the assay temperature. The tube was incubated for 15 minutes on the Eppendorf thermomixer at its highest shaking rate (1400 rpm.). The incubation was stopped by transferring the tube back to the ice bath. Then the tube was centrifuged in an ice cold centrifuge for a few minutes and 2004 supernatant was transferred to a microtiter plate. OD₆₅₀ was read as a measure of alpha-amylase activity. A buffer blind was included in the assay (instead of enzyme).

### Example 1

### Purification of the Beta-Glucanase from Bacillus amyloliquefaciens from Novozymes Commercial Product BAN 480L

The BAN 480L product is produced from a fermentation of a Bacillus amyloliquefaciens strain also secreting other enzyme activities such as amylase and protease. The secreted enzymes are isolated by filtration and concentrated by ultrafiltration. The BAN 480L product is a formulation of the ultrafiltrate with NaCl and glycerol.

To reduce the conductivity in the BAN 480L product in order to ensure binding on an ion-exchange column, the BAN 480L product was diluted 100× with deionised water and pH was adjusted to pH 4.5 with 20% CH₃COOH. The adjusted BAN 480L solution was applied to a S-sepharose FF column (from GE Healthcare) equilibrated in 20 mM CH₃COOH/NaOH, pH 4.5. After washing the column extensively with the equilibration buffer, the column was eluted with a linear NaCl gradient (0->0.5M) in the same buffer over five column volumes. Fractions from the column were analysed for beta-glucanase activity (AZCL-beta-glucan assay at pH 8), protease activity (Suc-AAPF-pNA assay at pH 8) and alpha-amylase activity (AZCL-amylose assay at pH 8). Fractions with high beta-glucanase activity, no protease or alpha-amylase activity were further analysed by SDS-PAGE. Pure fractions (only one band was seen on a coomassie stained gel) were pooled as the purified product and were used for further characterization and experiments.

Characterization of the Beta-Glucanase from Bacillus Amyloliquefaciens
Determination of the N-terminal sequence by EDMAN method was: QTGGSFFEFPFNSYNS.
The relative molecular weight as determined by SDS-PAGE was approx. Mᵣ=25 kDa.
The molecular weight determined by intact molecular weight analysis (LC-MS-TOF) gave two major mass peaks of equal intensity at 24155.9 Da and 24138.8 Da.
The mature sequence (as determined by MS data and EDMAN) is:

(SEQ ID NO: 2)
QTGGSFFEPFNSYNSGLWQKADGYSNGDMFNCTWRANNVSMTSSGEMRLA
LTSPSYNKFDCGENRSVQTYGYGLYEVRMKPAKNTGIVSSFFTYTGPTEG
TPWDEIDIEFLGKDTTKVQFNYYTNGAGNHEKLADLGFDAANAYHTYAFD
WQPNSIKWYVDGQLKHTATTQIPAAPGKIMMNLWNGTGVDDWLGSYNGVN
PLYAHYDWVRYTKK

The calculated molecular weight from this mature sequence was 24156.4 Da.

The observed peak at 24155.9 Da corresponds to the above mature sequence. The observed peak at 24138.8 Da corresponds to the above mature sequence with the N-terminal Q converted to pyroglutamate (loss of 17 Da). We therefore conclude that we have purified beta-glucanase from Bacillus amyloliquefaciens with the above mature sequence where approx. 50% of the molecules have a pyroglutamate residue at the N-terminus.

### Example 2

### Wash Performance

The wash performance of the beta-glucanase of the invention having SEQ ID NO: 2 was tested using the liquid model detergent A for 2 wash temperatures on 2 technical stains (035KC chocolate porridge oats and C-H097 cocoa/oat flakes) using the Terg-O-tometer (TOM) assay described above. The beta-glucanase was also tested in combination with an amylase (Stainzyme) and a protease (Savinase) and the results were assessed as described in the evaluation of stains for TOM. Stainzyme, Savinase, and Celluclean L used in the current example are commercial products of Novozymes (Novozymes NS; Krogshoejvej 36; 2880 Bagsvaerd; Denmark).

TABLE 2
Wash Performance of Chocolate Porridge Oats in Model
Detergent A at 20° C. and 40° C.

| | |
|---|---|
| 20° C. | 40° C. |

| | | Std. | | Std. |
|---|---|---|---|---|
| Enzyme | REM | Dev. | REM | Dev. |
| Blank | 60.8 | 2.1 | 67.5 | 3.2 |
| Beta-glucanase | 62.3 | 4.1 | 70.3 | 0.8 |
| Celluclean L | 59.2 | 3.1 | 70.0 | 2.9 |
| Stainzyme | 62.5 | 3.4 | 69.9 | 3.6 |
| Savinase | 59.8 | 3.4 | 65.2 | 0.4 |
| Beta-glucanase + Stainzyme | 78.9 | 2.2 | 88.2 | 0.7 |
| Celluclean L + Stainzyme | 78.8 | 1.6 | 85.9 | 1.9 |
| Beta-glucanase + Savinase | 62.9 | 4.9 | 71.8 | 3.8 |
| Celluclean L + Savinase | 60.9 | 1.4 | 73.5 | 5.8 |
| Beta-glucanase + Stainzyme + | 80.3 | 1.8 | 87.1 | 1.8 |
| Savinase | | | | |
| Celluclean L + Stainzyme + | 78.4 | 4.3 | 87.0 | 0.9 |
| Savinase | | | | |

TABLE 3
Wash Performance of Cocoa/Oat Flakes in Model Detergent
A at 20° C. and 40° C.

| | |
|---|---|
| 20° C. | 40° C. |

| | | Std. | | Std. |
|---|---|---|---|---|
| Enzyme | REM | Dev. | REM | Dev. |
| Blank | 46.7 | 2.6 | 51.4 | 2.0 |
| Beta-glucanase | 53.7 | 2.1 | 54.6 | 4.0 |
| Celluclean L | 50.8 | 2.6 | 53.6 | 2.3 |
| Stainzyme | 47.1 | 2.1 | 50.7 | 2.7 |
| Savinase | 48.3 | 2.4 | 52.0 | 3.4 |
| Beta-glucanase + Stainzyme | 56.3 | 3.5 | 57.3 | 2.4 |
| Celluclean L + Stainzyme | 54.3 | 4.7 | 63.3 | 1.9 |
| Beta-glucanase + Savinase | 54.4 | 4.8 | 59.0 | 3.3 |
| Celluclean L + Savinase | 51.4 | 3.4 | 61.3 | 4.0 |
| Beta-glucanase + Stainzyme + | 62.7 | 3.2 | 61.3 | 4.1 |
| Savinase | | | | |
| Celluclean L + Stainzyme + | 53.6 | 2.6 | 63.6 | 4.4 |
| Savinase | | | | |

The results show that the combination of the beta-glucanase of the invention and an amylase (Stainzyme) showed significant enzyme detergency benefit over the same wash conditions with no enzyme present. In addition, the combination of the beta-glucanase of the invention and an amylase showed a significantly improved wash performance over the beta-glucanase of the invention alone or an amylase alone on both chocolate porridge oats and cocoa/oat flakes at both 20 and 40° C. Furthermore, the combination of the beta-glucanase of the invention, an amylase and a protease shows the same or improved wash performance over the combination of the beta-glucanase of the invention and an amylase indicating that the beta-glucanase of the invention is stable to proteases under these wash conditions.

1. A cleaning or detergent composition comprising a beta-glucanase selected from the group consisting of:
(a) a polypeptide having at least 80% sequence identity to the mature polypeptide of SEQ ID NO: 2;
(b) a polypeptide encoded by a polynucleotide that hybridizes under medium stringency conditions with the mature polypeptide coding sequence of SEQ ID NO: 1 or the full-length complement thereof;
(c) a polypeptide encoded by a polynucleotide having at least 80% sequence identity to the mature polypeptide coding sequence of SEQ ID NO: 1;
(d) a variant of the mature polypeptide of SEQ ID NO: 2 comprising a substitution, deletion, and/or insertion at one or more (e.g. several) positions; and
(e) a fragment of the polypeptide of (a), (b), (c), or (d) that has beta-glucanase activity;
and one or more amylases.

2. The cleaning or detergent composition of claim 1, wherein the beta-glucanase corresponds to amino acids 1 to 214 of SEQ ID NO: 2.

3. The cleaning or detergent composition of claim 1, wherein the alpha-amylase is selected from the group consisting of:
(a) a polypeptide having at least 90% sequence identity to SEQ ID NO: 3;
(b) a polypeptide having at least 90% sequence identity to SEQ ID NO: 3 wherein the polypeptide comprises a substitution in one or more of positions: 15, 23, 105, 106, 124, 128, 133, 154, 156, 178, 179, 181, 188, 190, 197, 201, 202, 207, 208, 209, 211, 243, 264, 304, 305, 391, 408, and/or 444;
(c) a polypeptide having at least 90% sequence identity to SEQ ID NO: 4;
(d) a polypeptide having at least 90% sequence identity to the hybrid polypeptide of SEQ ID NO: 5;
(e) a polypeptide having at least 90% sequence identity to the hybrid polypeptide SEQ ID NO: 5 wherein the hybrid polypeptide comprises a substitution, a deletion or an insertion in one of more of positions: 48, 49, 107, 156, 181, 190, 197, 201, 209 and/or 264;
(f) a polypeptide having at least 90% sequence identity to SEQ ID NO: 6;
(g) a polypeptide having at least 90% sequence identity to SEQ ID NO: 6, wherein the polypeptide comprises a substitution, a deletion or an insertion in one of more of positions: 181, 182, 183, 184, 195, 206, 212, 216 and/or 269;
(h) a polypeptide having at least 90% sequence identity to SEQ ID NO: 7, SEQ ID NO: 8 or SEQ ID NO: 9;
(i) a polypeptide having at least 90% sequence identity to SEQ ID NO: 7, SEQ ID NO: 8 or SEQ ID NO: 9 wherein the polypeptide comprises a substitution, a deletion or an insertion in one of more of positions: 140, 183, 184 195, 206, 243, 260, 304 and/or 476;
(j) a polypeptide having at least 90% sequence identity to SEQ ID NO: 10;
(k) a polypeptide having at least 90% sequence identity to SEQ ID NO: 11;
(l) a polypeptide having at least 90% sequence identity to SEQ ID NO: 11, wherein the polypeptide comprises a substitution, a deletion or an insertion in one of more of positions: 176, 177, 178, 179, 190, 201, 207, 211 and/or 264;
(m) a polypeptide having at least 90% sequence identity to SEQ ID NO: 12;
(n) a polypeptide having at least 90% sequence identity to SEQ ID NO: 12, wherein the polypeptide comprises a substitution, a deletion or an insertion in one of more of positions: 87, 98, 125, 128, 131, 165, 178, 180, 181, 182, 183, 201, 202, 225, 243, 272, 282, 305, 309, 319, 320, 359, 444 and/or 475; and
(o) a polypeptide having at least 90% sequence identity to SEQ ID NO: 11, wherein the polypeptide comprises a substitution, a deletion or an insertion in one of more of positions: 28, 118, 174; 181, 182, 183, 184, 186, 189, 195, 202, 298, 299, 302, 303, 306, 310, 314; 320, 324, 345, 396, 400, 439, 444, 445, 446, 449, 458, 471 and/or 484.

4. The cleaning or detergent composition of claim 1, wherein the composition comprises one or more further enzymes selected from the group comprising of proteases, lipases, cutinases, cellulases, endoglucanases, xyloglucanases, pectinases, pectin lyases, xanthanases, peroxidaes, haloperoxygenases, catalases, mannanases, or any mixture thereof.

5. The cleaning or detergent composition of claim 1, wherein the composition comprises one or more proteases and optionally one or more further enzymes selected from the group comprising of lipases, cutinases, cellulases, endoglucanases, xyloglucanases, pectinases, pectin lyases, xanthanases, peroxidaes, haloperoxygenases, catalases, mannanases, or any mixture thereof.

6. The cleaning or detergent composition of claim 1, wherein the protease is a serine protease of the S1 or S8 family or a metalloprotease of the M4, M5, M7 or M8 family.

7. The cleaning or detergent composition of claim 1, wherein the protease is selected from the group consisting of:
(a) a polypeptide having at least 90% sequence identity to SEQ ID NO: 13;
(b) a polypeptide having at least 90% sequence identity to SEQ ID NO: 13, wherein the polypeptide comprises a substitution in one or more of positions: 9, 15, 27, 36, 68, 76, 87, 95, 96, 97, 98, 99, 100, 101, 102, 103, 104, 106, 118, 120, 123, 128, 129, 130, 160, 167, 170, 194, 195, 218, 222, 232, 235, 236, 245, 248, 252 and/or 274 using BPN′ numbering;
(c) a polypeptide having at least 90% sequence identity to the amino acid sequence of SEQ ID NO: 14; and
(d) a polypeptide having at least 90% sequence identity to the amino acid sequence of SEQ ID NO: 14 wherein the polypeptide comprises a substitution in one or more of positions: 3, 4, 99, 101, 103, 104, 159, 194, 199, 205 and/or 217.

8. The cleaning or detergent composition of claim 1 comprising one or more components selected from the group comprising of surfactants, builders, hydrotopes, bleaching systems, polymers, fabric hueing agents, adjunct materials, dispersants, dye transfer inhibiting agents, fluorescent whitening agents, soil release polymers and anti-redeposition agents.

9. The cleaning or detergent composition of claim 1 in which the composition is in form of a bar, a homogenous tablet, a tablet having two or more layers, a pouch having one or more compartments, a regular or compact powder, a granule, a paste, a gel, or a regular, compact or concentrated liquid.

10. The cleaning or detergent composition of claim 1 having an enzyme detergency benefit in cleaning or detergent applications.

11. The cleaning or detergent composition of claim 1 having an improved wash performance in cleaning or detergent applications.

12. A method for removing a stain from a surface which comprises contacting the surface with a composition of claim 1 according to any of claim 1.

13-15. (canceled)


SEQUENCE LISTING (14 sequences)

SEQ ID NO: 1 - DNA, 720 bp, Bacillus amyloliquefacience
  CDS (1)..(717)
  sig_peptide (1)..(75)
  mat_peptide (76)..(717)
atgaaacgagtgttgctaattcttgtcaccggattgtttatgagtttgtgtgggatcacttctagtgtttcggctcaaacaggcggatcgttttttgaaccttttaacagctataactccgggttatggcaaaaagctgatggttactcaaatggagatatgtttaactgcacttggcgtgcgaataacgtctctatgacgtcatcaggtgaaatgcgtttggcgctgacaagtccgtcttataacaagtttgactgcggggaaaaccgctcggttcaaacatatggctatggactttatgaagtcagaatgaaaccggctaaaaacacagggattgtttcatcgttcttcacttatacaggtccaacggaggggactccttgggatgagattgatatcgaatttttgggaaaagacacaacaaaggttcaatttaactattatacaaatggcgcaggaaaccatgagaagttggcggatctcggatttgatgcagccaatgcctatcatacgtatgcgttcgattggcagccaaactctattaaatggtatgtcgatgggcaattaaaacatactgcgacaacccaaataccggcagcgccggggaaaatcatgatgaatttgtggaatggtacgggtgtcgatgattggctcggttcctacaatggcgtaaatccgctatacgctcattacgactgggtgcgctatacaaaaaaataa

SEQ ID NO: 2 - protein, 239 aa, Bacillus amyloliquefacience
MKRVLLILVTGLFMSLCGITSSVSAQTGGSFFEPFNSYNSGLWQKADGYSNGDMFNCTWRANNVSMTSSGEMRLALTSPSYNKFDCGENRSVQTYGYGLYEVRMKPAKNTGIVSSFFTYTGPTEGTPWDEIDIEFLGKDTTKVQFNYYTNGAGNHEKLADLGFDAANAYHTYAFDWQPNSIKWYVDGQLKHTATTQIPAAPGKIMMNLWNGTGVDDWLGSYNGVNPLYAHYDWVRYTKK

SEQ ID NO: 3 - protein, 483 aa, Bacillus licheniformis [sequence omitted]

SEQ ID NO: 4 - protein, 515 aa, Bacillus stearothermophilus
AAPFNGTMMQYFEWYLPDDGTLWTKVANEANNLSSLGITALWLPPAYKGTSRSDVGYGVYDLYDLGEFNQKGTVRTKYGTKAQYLQAIQAAHAAGMQVYADVVFDHKGGADGTEWVDAVEVNPSDRNQEISGTYQIQAWTKFDFPGRGNTYSSFKWRWYHFDGVDWDESRKLSRIYKFRGIGKAWDWEVDTENGNYDYLMYADLDMDHPEVVTELKNWGKWYVNTTNIDGFRLDAVKHIKFSFFPDWLSYVRSQTGKPLFTVGEYWSYDINKLHNYITKTDGTMSLFDAPLHNKFYTASKSGGAFDMRTLMTNTLMKDQPTLAVTFVDNHDTEPGQALQSWVDPWFKPLAYAFILTRQEGYPCVFYGDYYGIPQYNIPSLKSKIDPLLIARRDYAYGTQHDYLDHSDIIGWTREGGTEKPGSGLAALITDGPGGSKWMYVGKQHAGKVFYDLTGNRSDTVTINSDGWGEFKVNGGSVSVWVPRKTTVSTIARPITTRPWTGEFVRWTEPRLVAWP

SEQ ID NO: 5 - protein, 481 aa, Artificial sequence
  Synthetic construct
VNGTLMQYFEWYTPNDGQHWKRLQNDAEHLSDIGITAVWIPPAYKGTSQADVGYGAYDLYDLGEFHQKGTVRTKYGTKGELQSAIKSLHSRDINVYGDVVINHKGGADATEDVTAVEVDPADRNRVISGEHLIKAWTHFHFPGRGSTYSDFKWHWYHFDGTDWDESRKLNRIYKFQGKAWDWEVSNENGNYDYLMYADIDYDHPDVAAEIKRWGTWYANELQLDGFRLDAVKHIKFSFLRDWVNHVREKTGKEMFTVAEYWQNDLGALENYLNKTNFNHSVFDVPLHYQFHAASTQGGGYDMRKLLNGTVVSKHPLKSVTFVDNHDTQPGQSLESTVQTWFKPLAYAFILTRESGYPQVFYGDMYGTKGDSQREIPALKHKIEPILKARKQYAYGAQHDYFDHHDIVGWTREGDSSVANSGLAALITDGPGGAKRMYVGRQNAGETWHDITGNRSEPVVINSEGWGEFHVNGGSVSIYVQR

SEQ ID NO: 6 - protein, 485 aa, Bacillus sp.
HHNGTNGTMMQYFEWYLPNDGNHWNRLNSDASNLKSKGITAVWIPPAWKGASQNDVGYGAYDLYDLGEFNQKGTVRTKYGTRSQLQAAVTSLKNNGIQVYGDVVMNHKGGADATEMVRAVEVNPNNRNQEVTGEYTIEAWTRFDFPGRGNTHSSFKWRWYHFDGVDWDQSRRLNNRIYKFRGHGKAWDWEVDTENGNYDYLMYADIDMDHPEVVNELRNWGVWYTNTLGLDGFRIDAVKHIKYSFTRDWINHVRSATGKNMFAVAEFWKNDLGAIENYLQKTNWNHSVFDVPLHYNLYNASKSGGNYDMRNIFNGTVVQRHPSHAVTFVDNHDSQPEEALESFVEEWFKPLAYALTLTREQGYPSVFYGDYYGIPTHGVPAMRSKIDPILEARQKYAYGKQNDYLDHHNIIGWTREGNTAHPNSGLATIMSDGAGGSKWMFVGRNKAGQVWSDITGNRTGTVTINADGWGNFSVNGGSVSIWVNK

SEQ ID NO: 7 - protein, 485 aa, Bacillus sp.
HHNGTNGTMMQYFEWYLPNDGNHWNRLRDDAANLKSKGITAVWIPPAWKGTSQNDVGYGAYDLYDLGEFNQKGTVRTKYGTRNQLQAAVTSLKNNGIQVYGDVVMNHKGGADGTEIVNAVEVNRSNRNQETSGEYAIEAWTKFDFPGRGNNHSSFKWRWYHFDGTDWDQSRQLQNKIYKFRGTGKAWDWEVDTENGNYDYLMYADVDMDHPEVIHELRNWGVWYTNTLNLDGFRIDAVKHIKYSFTRDWLTHVRNTTGKPMFAVAEFWKNDLGAIENYLNKTSWNHSVFDVPLHYNLYNASNSGGYYDMRNILNGSVVQKHPTHAVTFVDNHDSQPGEALESFVQQWFKPLAYALVLTREQGYPSVFYGDYYGIPTHGVPAMKSKIDPLLQARQTFAYGTQHDYFDHHDIIGWTREGNSSHPNSGLATIMSDGPGGNKWMYVGKNKAGQVWRDITGNRTGTVTINADGWGNFSVNGGSVSVWVKQ

SEQ ID NO: 8 - protein, 485 aa, Bacillus sp.
HHNGTNGTMMQYFEWHLPNDGNHWNRLRDDASNLRNRGITAIWIPPAWKGTSQNDVGYGAYDLYDLGEFNQKGTVRTKYGTRSQLESAIHALKNNGVQVYGDVVMNHKGGADATENVLAVEVNPNNRNQEISGDYTIEAWTKFDFPGRGNTYSDFKWRWYHFDGVDWDQSRQFQNRIYKFRGDGKAWDWEVDSENGNYDYLMYADVDMDHPEVVNELRRWGEWYTNTLNLDGFRIDAVKHIKYSFTRDWLTHVRNATGKEMFAVAEFWKNDLGALENYLNKTNWNHSVFDVPLHYNLYNASNSGGNYDMAKLLNGTVVQKHPMHAVTFVDNHDSQPGESLESFVQEWFKPLAYALILTREQGYPSVFYGDYYGIPTHSVPAMKAKIDPILEARQNFAYGTQHDYFDHHNIIGWTREGNTTHPNSGLATIMSDGPGGEKWMYVGQNKAGQVWHDITGNKPGTVTINADGWANFSVNGGSVSIWVKR

SEQ ID NO: 9 - protein, 485 aa, Bacillus sp.; identical to SEQ ID NO: 6

SEQ ID NO: 10 - protein, 485 aa, Bacillus sp.
HHNGTNGTMMQYFEWYLPNDGNHWNRLRSDASNLKDKGITAVWIPPAWKGASQNDVGYGAYDLYDLGEFNQKGTVRTKYGTRNQLQAAVTALKSNGIQVYGDVVMNHKGGADATEWVRAVEVNPSNRNQEVSGDYTIEAWTKFDFPGRGNTHSNFKWRWYHFDGVDWDQSRQLQNRIYKFRGDGKGWDWEVDTENGNYDYLMYADIDMDHPEVVNELRNWGVWYTNTLGLDGFRIDAVKHIKYSFTRDWLTHVRNTTGKNMFAVAEFWKNDIGAIENYLSKTNWNHSVFDVPLHYNLYNASRSGGNYDMRQIFNGTVVQRHPTHAVTFVDNHDSQPEEALESFVEEWFKPLAYALTLTRDQGYPSVFYGDYYGIPTHGVPAMKSKIDPILEARQKYAYGKQNDYLDHHNMIGWTREGNTAHPNSGLATIMSDGPGGNKWMYVGRNKAGQVWRDITGNRSGTVTINADGWGNFSVNGGSVSIWVNN

SEQ ID NO: 11 - protein, 483 aa, Bacillus amyloliquefaciens
VNGTLMQYFEWYTPNDGQHWKRLQNDAEHLSDIGITAVWIPPAYKGLSQSDNGYGPYDLYDLGEFQQKGTVRTKYGTKSELQDAIGSLHSRNVQVYGDVVLNHKAGADATEDVTAVEVNPANRNQETSEEYQIKAWTDFRFPGRGNTYSDFKWHWYHFDGADWDESRKISRIFKFRGEGKAWDWEVSSENGNYDYLMYADVDYDHPDVVAETKKWGIWYANELSLDGFRIDAAKHIKFSFLRDWVQAVRQATGKEMFTVAEYWQNNAGKLENYLNKTSFNQSVFDVPLHFNLQAASSQGGGYDMRRLLDGTVVSRHPEKAVTFVENHDTQPGQSLESTVQTWFKPLAYAFILTRESGYPQVFYGDMYGTKGTSPKEIPSLKDNIEPILKARKEYAYGPQHDYIDHPDVIGWTREGDSSAAKSGLAALITDGPGGSKRMYAGLKNAGETWYDITGNRSDTVKIGSDGWGEFHVNDGSVSIYVQK

SEQ ID NO: 12 - protein, 484 aa, Bacillus sp.
NTAPINETMMQYFEWDLPNDGTLWTKVKNEAANLSSLGITALWLPPAYKGTSQSDVGYGVYDLYDLGEFNQKGTIRTKYGTKTQYIQAIQAAKAAGMQVYADVVFNHKAGADGTEFVDAVEVDPSNRNQETSGTYQIQAWTKFDFPGRGNTYSSFKWRWYHFDGTDWDESRKLNRIYKFRSTGKAWDWEVDTENGNYDYLMFADLDMDHPEVVTELKNWGTWYVNTTNIDGFRLDAVKHIKYSFFPDWLTYVRNQTGKNLFAVGEFWSYDVNKLHNYITKTNGSMSLFDAPLHNNFYTASKSSGYFDMRYLLNNTLMKDQPSLAVTLVDNHDTQPGQSLQSWVEPWFKPLAYAFILTRQEGYPCVFYGDYYGIPKYNIPGLKSKIDPLLIARRDYAYGTQRDYIDHQDIIGWTREGIDTKPNSGLAALITDGPGGSKWMYVGKKHAGKVFYDLTGNRSDTVTINADGWGEFKVNGGSVSIWVAK

SEQ ID NO: 13 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 14 - protein, 269 aa, Bacillus lentus
AQTVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR